(19) United States
(12) Patent Application Publication
(10) Pub. No.: US 2024/0035296 A1
(43) Pub. Date: Feb. 1, 2024

(54) FLEXIBLE USE DWELLING

(71) Applicant: Irena Matulic, Belmont, MA (US)

(72) Inventor: Irena Matulic, Belmont, MA (US)

(21) Appl. No.: 18/228,572

(22) Filed: Jul. 31, 2023

Related U.S. Application Data
(60) Provisional application No. 63/393,584, filed on Jul. 29, 2022.

(51) Int. Cl. E04H 1/00; G06Q 50/16

(52) U.S. Cl. CPC E04H 1/00; G06Q 50/163

(57) ABSTRACT

A home is designed for a conventional construction, with a flexibility of use of spaces enabled by four design features: a design of a kitchen that can be readily used as two separate kitchens, a master bedroom built-in that can readily be used as a kitchenette, a floor plan designed to allow divisions of home areas into separate independent units with a required means of egress by simply closing and locking of a few doors, and by a universal/ADA design of the home.

### RELATED APPLICATION

This application claims benefit of and priority to U.S. Provisional Application No. 63/393,584, filed Jul. 29, 2022, the content of which is incorporated by reference herein in its entirety.

### FIELD OF THE INVENTION

The present invention pertains to a new single-family home typology, designed as a hybrid of a compact multifamily home for conventional construction with flexibility in use of spaces, to allow a variety of readily available size and layout live/work options within a home.

### BACKGROUND

### About Comfort and Quality of Living:

Our lives constantly change, and typical homes are not designed to accommodate and support changes, but to temporary accommodate the owner's needs, lifestyle, financial and family situation. Even the most comfortably designed homes, to accommodate changes over time, require renovations which are often costly, disruptive for the family and environmentally wasteful. Once the renovation is completed, it suits the owner's needs again temporarily, and the process continues and repeats, deeply affecting the owner's comfort and quality of living.

Some embodiments of the present invention and support changes in use without modifications, with a flexibility in use that may allow for a home to suit the owner's needs comfortably for a lifetime.

### About Affordability:

Home affordability has been critically low for a long time now and there are no signs of substantial improvement yet. Affordability is one of today's hottest topics and deeply affects us all.

The typical approach to affordable homeownership has been a lifelong process of buying a modest starter home, upgrading, selling, buying again, and renovating or downsizing as income and needs fluctuate. Traditional income-generating home solutions, like double- and triple-deckers, have proved difficult to manage.

New affordable home solutions have focused mainly on temporary or partial resolutions, on sacrificing quality, comfort or privacy, reducing size, lowering material and labor costs, overburdening the owners with investment and construction phasing. New multifamily options are often fragmented and very unique solutions difficult to implement.

Some embodiments of the present invention may eliminate a lifetime of compromise usually associated with affordable living.

### About Efficiency:

A typical home is not designed for a high efficiency. It fits the owner's lifestyle and is used to a full capacity for only a limited time. For that reason a large number of homes remain underused. On the other side, a building industry and environment has one of the biggest impacts on climate change and is often remarkably inefficient.

Significant efforts have been directed towards more efficient materials, building techniques and practices, but not towards the wastefulness, density and the actual efficiency of the building environment.

Some embodiments of the present invention may enable for long-term continuous full-capacity use of a home.

It is to these ends that that some embodiments the present invention has been developed.

### SUMMARY

Some embodiments of the present invention provide a new single-family home typology with a significantly greater comfort, affordability and efficiency, by providing a variety of size and layout living options for the owner, and a variety of separate living options for extended family/rentals within a home. Some embodiments may significantly improve middle-income quality of living.

An embodiment provides single dwelling in an enclosable space defined by perimeter walls. The single dwelling including at least three bedrooms and three bathrooms, and dividable into three readily available individual units without any construction required. In some embodiments, the three individual units can be used combined as well, for a total of seven different available size and layout combinations of use. In some embodiments, units not used can be configured for renting out individually, allowing for a six different size and layout renting out options.

In some embodiments, the dwelling is organized around a central kitchen, which is directly connected to two multifunctional rooms (e.g., a living room and a dining room), collectively forming a living core of the dwelling.

In some embodiments, the kitchen is divided in two by a first interior wall forming a main kitchen area and a secondary kitchen area. The first interior wall dividing the kitchen has a cased opening sized to accommodate at least a single door forming a first interior doorway. In some embodiments, the two multifunctional rooms are separated from each other by a second interior wall having a cased opening sized to accommodate at least a single door forming a second interior doorway. By closing the doors of the first interior doorway and the second interior doorway, the living core can be separated into two independent living cores, with the multifunctional rooms (e.g., living and dining rooms) both sized to function as an individual living/dining rooms, and located in such a way that each has a direct access to one of the two divided parts of the kitchen (e.g., the main kitchen area Kitchen-M and the secondary kitchen area Kitchen-S).

In some embodiments, each of the divided living cores has direct access to a bedroom suite of at least one bedroom and one bathroom. In some embodiments, the bedrooms are comfortably sized, for the smallest bedroom to allow at least a queen size bed with side tables, closet and a desk, when the smallest bedroom is a part of the double bedroom suite. In some embodiments, each bedroom suite is sized and configured to accommodate, at least, a king bed with side tables, a walk-in closet, a desk, and a chest of drawers.

In some embodiments, the bedroom suite on the side of the secondary kitchen area is ADA group 2 accessible, with the larger bathroom to accommodate a wheelchair turn clearance and with the ADA-compliant plumbing fixtures. In some embodiments, each of the multiuse rooms (e.g., Dining/living rooms) is sized to accommodate a small dining room table with four chairs, a seating area with a sofa and chairs, a desk, a TV and a living bookcase storage furniture and to provide a wheelchair turning space. In some embodiments the secondary kitchen are is ADA group 2 accessible, as well as the rest of the unit.

In some embodiments the dwelling has a main entry and a secondary entry that are separated from each other by a distance of at least one third of a length of a shorter diagonal line of the dwelling. Each entry leads to a corresponding hall. In some embodiments, the halls meeting meet in the center of the dwelling, separated by a wall in which there is a cased opening sized for an interior doorway. In some embodiments, each of the two halls allows entry to a single one of the separate living cores with adjacent bedroom suites, enabling them to be used as individual units. In some embodiments, the living core of the dwelling is accessible from both halls.

In some embodiments, a master bedroom suite is located across both halls, apart from the rest of the dwelling. From one hall the master bedroom suite is accessible through an entryway, and from the other hall the master bedroom suite is accessible directly through the master bedroom. The two entries to the master bedroom suite separated by a distance of at least a third of a length of a shorter diagonal distance of the master bedroom suite.

In some embodiments, the size and layout of the master bedroom suite is configured for use as a micro-unit or a studio apartment.

In some embodiments, the three individual units have perimeter walls and doors in those walls perimeter walls having a fire rating as required by local or state building codes. In some embodiments, the doors in the perimeter walls are lockable.

In some embodiments, the bedroom suites are located on a ground floor at a height accessible from a street. In some embodiments, at least one of the bedroom suites or the master suite has an additional exterior door enabling it to be used as a home based business or a commercial space.

In some embodiments, the dwelling is employed in a stand-alone home, in an apartment, in a condo, in a townhouse, in a triple-decker flat, etc.

In some embodiments, the dwelling universally designed to allow for a handicap use with hallway widths, door widths, locations and spacings, bedroom, kitchen, dining room, pantry, bathrooms and hall sizes and layouts configured to allow handicap entry, passage and use per ADA group 1.

In some embodiments, the kitchen is configured to be used as a fully functional single kitchen and also readily usable as two individual kitchens, without any construction required.

In some embodiments, the kitchen includes a main kitchen area and a secondary kitchen area, divided by a wall, with a cased opening configured for a double wide interior doorway for double doors wide enough and located in such a way to allow for the main and secondary kitchen areas to feel connected as a one single kitchen. The double doors are sized and located in such a way to lean against walls in a wide-open position, to be able to remain fully open at all times without blocking access to other portions of the dwelling.

In some embodiments, the main kitchen area is configured to hold a main sink, a dishwasher, an oven, a refrigerator and a freezer, a cooktop with a hood and a pantry. In some embodiments, the dwelling includes countertops at 36″ high, with the exception of the countertops in the main sink and the cooktop areas, which at 34″ high. In some embodiments, countertop areas next to the sink and the cooktop are to be at least 12″ wide. In some embodiments, the countertop areas next to the sink a cooktop can be covered with a removable 2″ high wood boards, to bring the countertop height to 36″ to match the rest, and be designed in such a way to allow for drying dishes, food cutting and chopping, or as flat functional countertops. In some embodiments, the dwelling includes bottom cabinets under the main sink and the cooktop that are either fully open or with removable cabinet doors, at least 30″ wide clear, to allow for a wheelchair use. In some embodiments, the dwelling includes upper cabinets at 52″ above the floor, to comply with the ADA requirements. All appliances to be ADA accessible. In some embodiments, the kitchen is configured to be fully ADA group 1 compliant by just a removal of the countertop wood boards and cabinet doors below the cooktop/sink. In some embodiments, the upper cabinets have a second tier of cabinets.

In some embodiments, the secondary kitchen area is configured to have a smaller sink, a smaller refrigerator with a freezer, and a wall oven. In some embodiments, the dwelling includes countertops that are 36″ high, the exception of the countertop at the sink area, which is 34″ high. The reduced height countertop area next to the sink being at least as wide as required to be ADA compliant. In some embodiments, reduced height countertop area next to the sink is covered by a removable 2″ high bread board, to bring the countertop height to 36″ to match the rest. In some embodiments, bottom cabinets under the sink in the secondary kitchen are fully open and at least 30″ wide, to allow for a handicap use. In some embodiments, upper cabinets in the secondary kitchen are 52″ above the floor, to comply with the ADA requirements. In some embodiments, kitchen appliances in the secondary kitchen are a ADA accessible. In some embodiments, the secondary kitchen area is fully ADA group 2 compliant by just a removal of the countertop wood board. In some embodiments, upper cabinets of the secondary kitchen area have a second tier of cabinets.

In some embodiments, the kitchen dividing wall and door to are fire rated and lockable so that, when the door is closed, the main and the secondary kitchen areas can function independently as two kitchens (e.g., Kitchen-M (Medium) and Kitchen-S(Small) respectively). In some embodiments, the secondary kitchen area of the dwelling includes a kitchen sink and a flat electric cooktop and the lower 34″ countertop level, and a hood above the flat electric cooktop, both ADA accessible, to be used for cooking when the secondary kitchen area is used as a separate independent Kitchen-S.

In some embodiments, the main kitchen area is fully functional as an independent kitchen (e.g., Kitchen-M) without any structural changes. In some embodiments the secondary kitchen area is fully functional as an independent kitchen (e.g., Kitchen-S) without any structural changes.

In some embodiments, master suite is configured to be readily usable as a micro unit/studio, without any construction required.

In some embodiments, the master suite includes a built-in unit having a 5′-6″ wide countertop with a sink and is open under the sink to allow for a wheelchair required legroom. In some embodiments, on one end, built-in cabinets are configured to contain a refrigerator/freezer and on the other end a cabinet is configured to hold a wall oven. In some embodiments, the built-in unit includes other built-in cabinets on each end and built-in cabinets above the open countertop area to be standard storage cabinets with shelves and drawers. In some embodiments, the built-in unit open countertop area has two full panel folding doors that slide into respective side pockets when fully open. In some embodiments, each of the folding doors can independently be fully closed or fully open. In some embodiments, cabinets surrounding the open built-in unit counter area are deep enough for the cabinet doors to be flush with the face of fully closed built-in unit folding doors when in a fully closed position.

In some embodiments, the built-in has removable bread board on top of the counter, to be used as a desk surface. In some embodiments, the sink has a top fitting tightly for a continuous flush countertop surface. In some embodiments, the built-in has a faucet with a spout configured to be rotated or an orientation parallel to the wall for the sink area to be used as a flat desk area. In some embodiments, the built-in unit has removable undercounter face panels that can be removed for desk chair legroom. In some embodiments, the built-in unit has a side bottom cabinet including a drawer and including a panel door enclosed a space sized to hold a trash can. In some embodiments the built-in has a side cabinet sized and configured for use as a filing cabinet. In some embodiments, the built-in unit has electric cooktop flush with the counter and a hood above the electric cooktop to enable the built-in unit to be used for cooking and to be used as a kitchenette. In some embodiments, the built-in unit has side cabinet sized and configured to hold a wall oven.

In some embodiments the master suite is sized and configured to hold a dining room table with four chairs, a sleeper sofa and chairs, a built-in closet, a tv with a cabinet, a storage cabinet and a wheelchair turning space. In some embodiments, the entryway and bathroom are sized and configured for ADA accessibility, group 1. In some embodiments, the master suite is sized and dimensioned for a universally/ADA studio independent unit.

In some embodiments, all built-in appliances of the master suite are ADA accessible. In some embodiments, open space below the sink and electric cooktop are wide enough to allow for ADA wheelchair clearance, and the whole built-in unit is ADA accessible.

One example embodiment is a conventional four-bedroom, three-bathroom compact home (e.g., of about 2,000 sf). The overall functional layout enables the home to be divided into separate units without any construction modifications, by simply opening and closing a few doors and making furniture adjustments. The innovative kitchen design enables the kitchen to be readily split into two separate kitchens. In an example embodiment, a master bedroom includes a built-in unit to be used as a wet bar, a kitchenette, or a workspace. The design of the kitchen, the door and room placement, and the master bedroom built-in unit enable the home to function as three separate units: a studio, a one bedroom, and a two bedroom. Each of these three units can be used individually or combined in a variety of ways for up to twenty-nine different size and layouts live/work options, depending on zoning and building type. Each layout is designed to feel like a home in itself. In some embodiments, the home is suitable for various family structures and for up to eight people. It can be used by a single family, for an extended family, and for rental.

This versatility of use may enable homeownership entry at any stage of life—for a single owner, a young expanding family, an older family with children growing up and going off to college, or for empty nesters. Embodiments of the present invention may accommodate the rapid and multiple changes—changes in space needs, working at home, developing and growing a business, and extended guest and family visits, also supporting social and family connections.

Some embodiments of the present invention provide support through changes in health and physical abilities as well. With universal/ADA design, some embodiments can be accessed and used regardless of a person's age or ability.

Some embodiments of the present invention provide a long-term housing solution that may improve neighborhood stability by anchoring diverse and connected mixed-income communities. This may stabilize and connect city neighborhoods, strengthening the neighborhood and wider social connections.

Some embodiments may significantly improve financial wellbeing as well. In addition to eliminating the need for a lifetime of costly renovations and moves, wealth-building is enabled by the accommodation of a variety of live/work options, from working at home to developing and running a business, and by availability of areas not needed by the owner to be readily rented out. Some embodiments are sized for optimal rental manageability and outstanding monthly affordability for a wide variety of middle-income owners. In some embodiments, the homeowners can save and invest the money they gain by spending less than the usual 30% of their income for housing.

Some embodiment provide a variety of financial options that give owners increased support while weathering the inevitable ups and downs of life, such as unplanned income fluctuations, financially vulnerable times, the need to provide child or elderly care. As such, some embodiments may support resiliency, security and upward mobility, giving middle-income families a means to own a home and prosper.

Some embodiments enable increased or maximized use of building resources and increased sustainability.

The above-mentioned advantages and superior features of various embodiments of the invention are described further in more detail through following descriptions, drawings and tables.

### BRIEF DESCRIPTIONS OF DRAWINGS

The drawings are intended to illustrate aspects and embodiments described herein and are not intended to limit the scope of examples or embodiments. In the drawings like elements are marked throughout the specification and drawings with the same reference numerals to reference like features and components of like function.

FIG. 1 is a floor plan of a first exemplary dwelling illustrating option of use #1—Single family home: 4-Bedroom (BR) Appt. (e.g., Owner occupied).

FIG. 2 is a floor plan of the first exemplary dwelling illustrating option of use #2—Two family home: 3-BR Appt. (e.g., Owner occupied)+Studio (e.g., Extended Family/Rental).

FIG. 3 is a floor plan of the first exemplary dwelling illustrating Option of use #3—Two family home: 3-BR Appt. (e.g., Owner occupied)+1-BR Appt. (e.g., Extended Family/Rental).

FIG. 4 is a floor plan of the first exemplary dwelling illustrating Option of use #4—Two family home: 2-BR Appt. (e.g., Owner occupied)+2-BR Appt. (e.g., Extended Family/Rental).

FIG. 5 is a floor plan of the first exemplary dwelling illustrating Option of use #5—Three family home: 2-BR Appt. (e.g., Owner occupied)+1-BR Appt. (e.g., Extended Family/Rental)+Studio (e.g., Extended Family/Rental).

FIG. 6 is a floor plan of the first exemplary dwelling illustrating Option of use #6—Three family home: 1-BR Appt. (e.g., Owner occupied)+2-BR Appt. (e.g., Extended Family/Rental)+Studio (e.g., Extended Family/Rental).

FIG. 7 is a floor plan of the first exemplary dwelling illustrating Option of use #7—Three family home: Studio 1-BR Appt. (e.g., Owner occupied)+2-BR Appt. (e.g., Extended Family/Rental)+1-BR Appt. (e.g., Extended Family/Rental)

FIGS. 8 through 29 are floor plans of the first exemplary dwelling illustrating Option of use #8 through Option of use #29—Living options #1 through #7 with designated spaces used as home offices and home-based businesses in twenty-two different ways.

FIGS. 30 through 41 are plan, elevations and 3D model views of a kitchen, when used undivided as a single kitchen (e.g., Kitchen-L (Large)) in accordance with some embodiments.

FIGS. 42 through 46 are plan, elevations and 3D model views of a pantry in accordance with some embodiments.

FIGS. 47 through 49 are plan and 3D model views of the kitchen when used as handicap accessible (e.g., Kitchen-L (Large) Universal Design/ADA) in accordance with some embodiments.

FIGS. 50 through 56 are plan, elevations and 3D model views of the main kitchen area when used as an independent kitchen (e.g., Kitchen-M (Medium)) in accordance with some embodiments.

FIGS. 57 through 63 are plan, elevations, and 3D model views of the secondary kitchen area when used as an independent kitchen (e.g., Kitchen-S(Small) in accordance with some embodiments.

FIGS. 64 through 69 are plan, elevations, and 3D model views of a master suite built-in unit when used as a wet bar (e.g., Built-in Unit, Wet bar use) in accordance with some embodiments.

FIGS. 70 through 72 are plan, elevations, and 3D model views of the master suite built-in unit when used as a home office (e.g., Built-in Unit, Home Office use) in accordance with some embodiments.

FIGS. 73 through 75 are plan, elevations, and 3D model views of the master suite built-in unit when used as a kitchenette (e.g., Built-in Unit, Kitchenette use) in accordance with some embodiments.

FIGS. 76 through 78 are plan, elevations, and 3D model views of the master suite built-in unit when used as a handicap accessible kitchenette (e.g., Built-in Unit, Kitchenette use, Universal/ADA) in accordance with some embodiments.

FIGS. 79 through 82 are floor plans for a second exemplary dwelling and a third exemplary dwelling in a triple-decker building type.

FIGS. 83 and 84 are floor plans for a two floor exemplary dwelling useable as a single family home and useable as a two-family home in accordance with an embodiment.

FIGS. 85 through 87 are floor plans for a three floor exemplary dwelling useable as a single family home and useable as a two-family home in accordance with an embodiment.

FIG. 88 is a floor plan for a single floor dwelling useable as a single family home and useable as a two-family home in accordance with an embodiment.

### BRIEF DESCRIPTIONS OF TABLES

Table 1: The DHM® Affordability table, per yearly gross income
Table 2: The DHM® Affordability table, per monthly gross income
Table 3: Compact Unit Size
Table 4: The DHM® Affordability summary table, with monthly savings
Table 5: Mnthly Property Oper. Data for Option of Use #1
Table 6: Mnthly Property Oper. Data for Option of Use #2
Table 7: Mnthly Property Oper. Data for Option of Use #3
Table 8: Mnthly Property Oper. Data for Option of Use #4
Table 9: Mnthly Property Oper. Data for Option of Use #5
Table 10: Mnthly Property Oper. Data for Option of Use #6
Table 11: Mnthly Property Oper. Data for Option of Use #7

### DETAILED DESCRIPTION

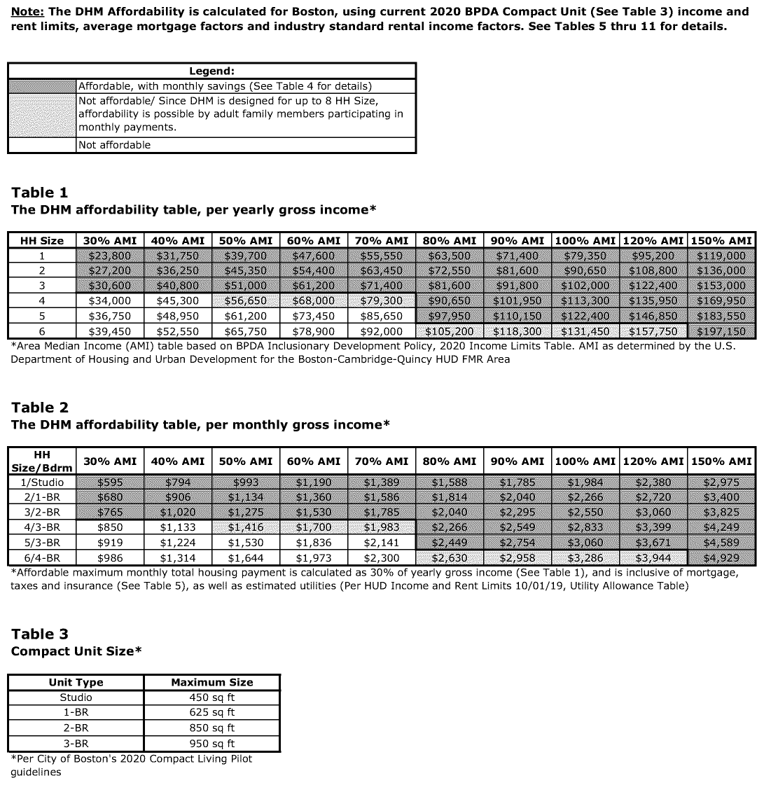

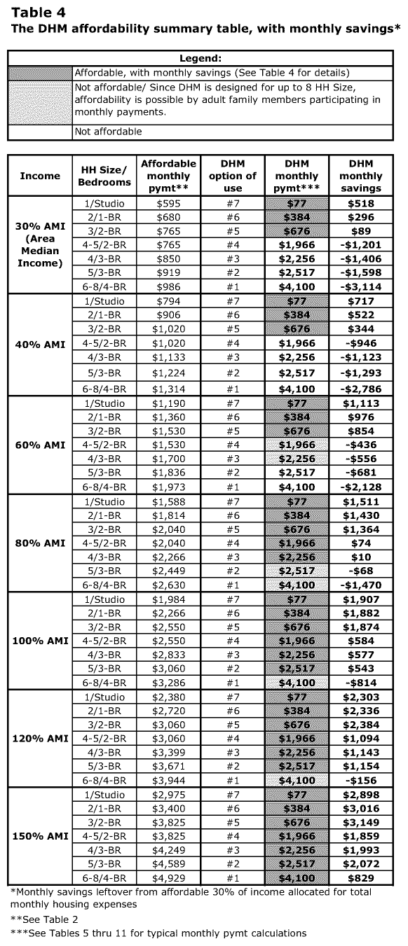

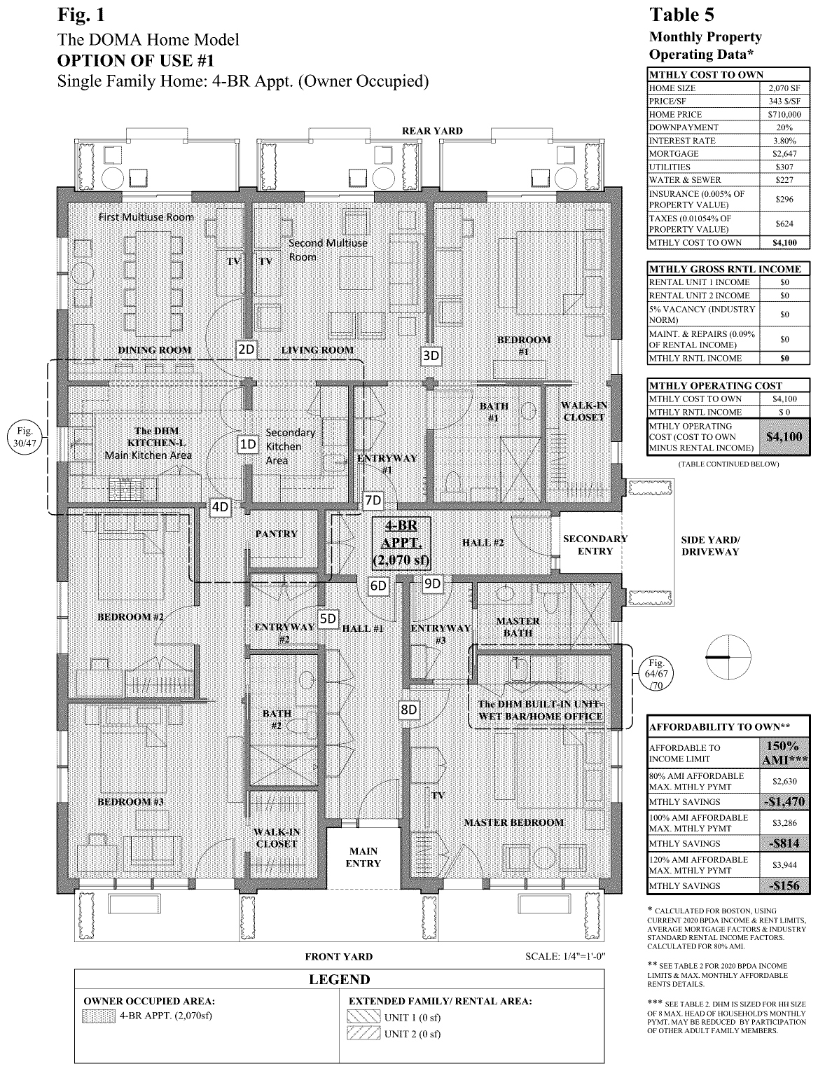

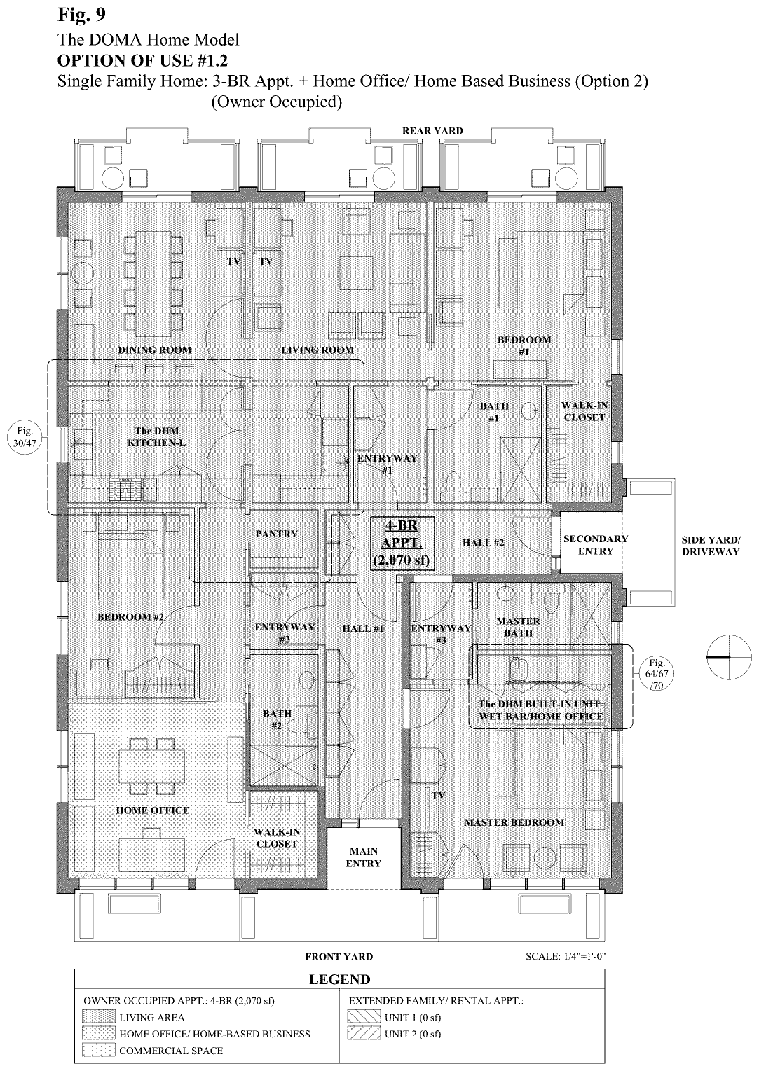

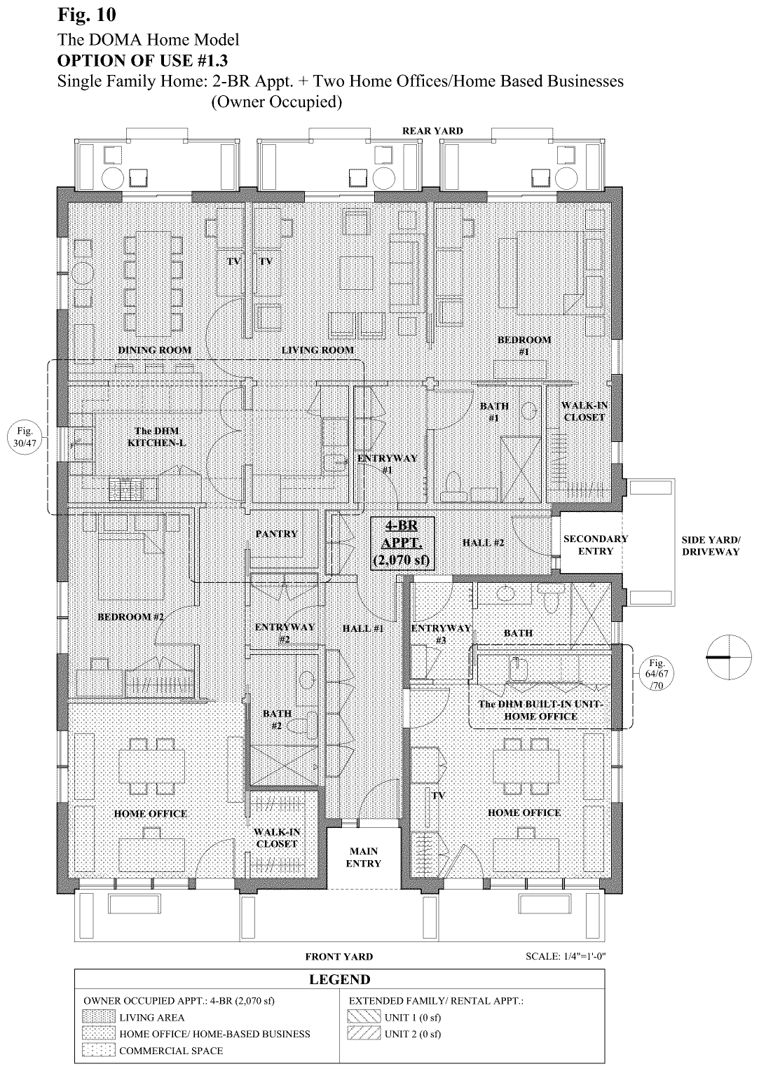

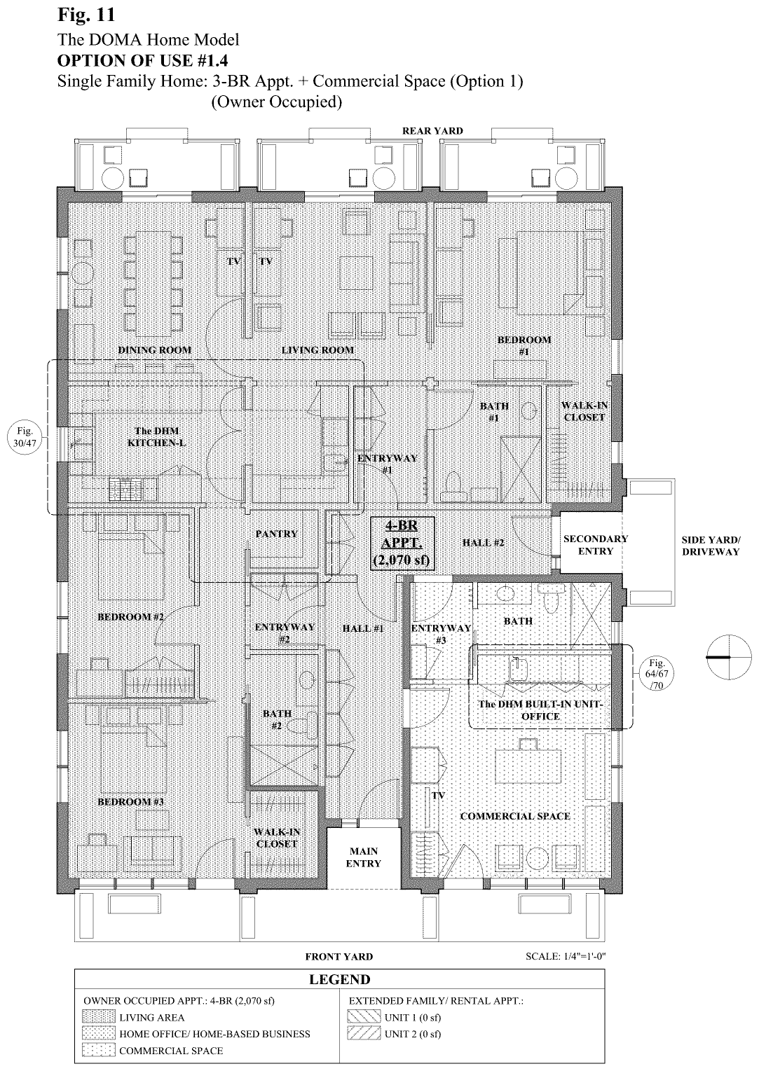

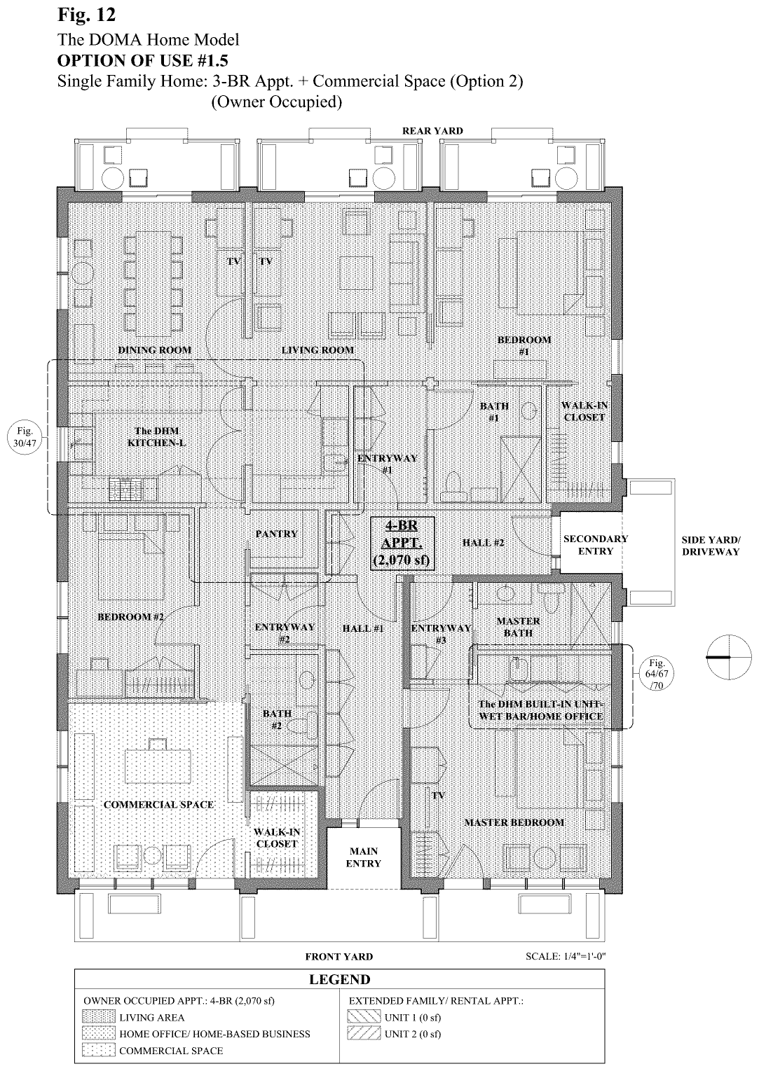

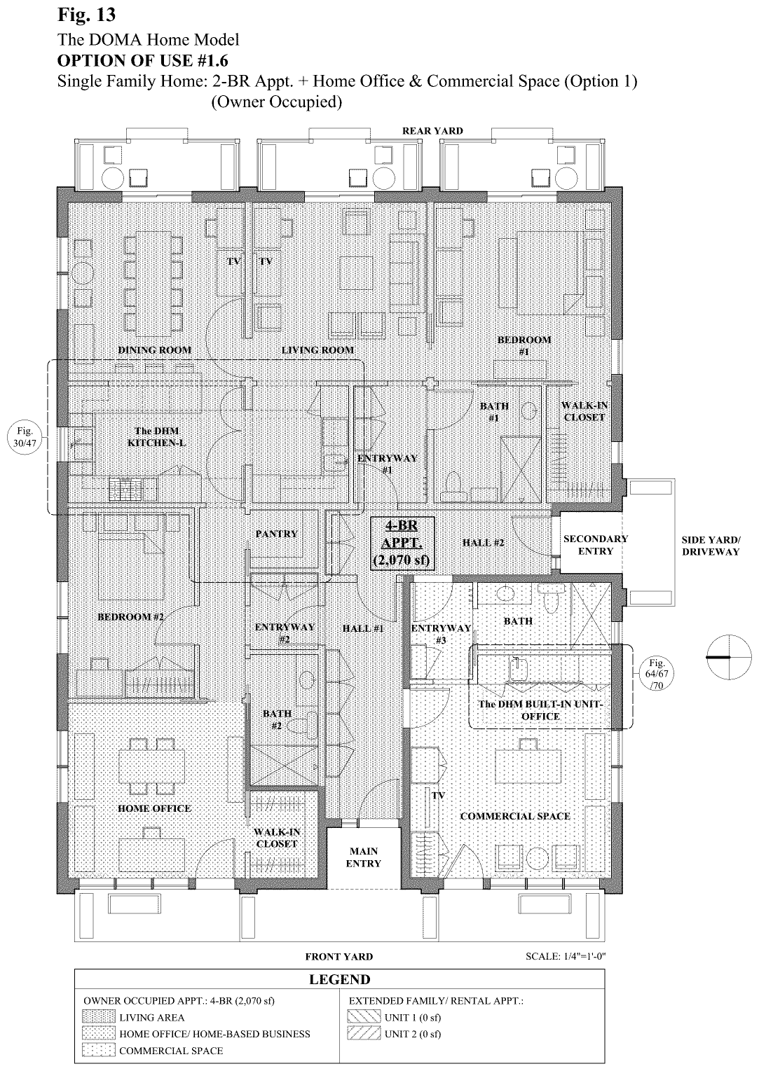

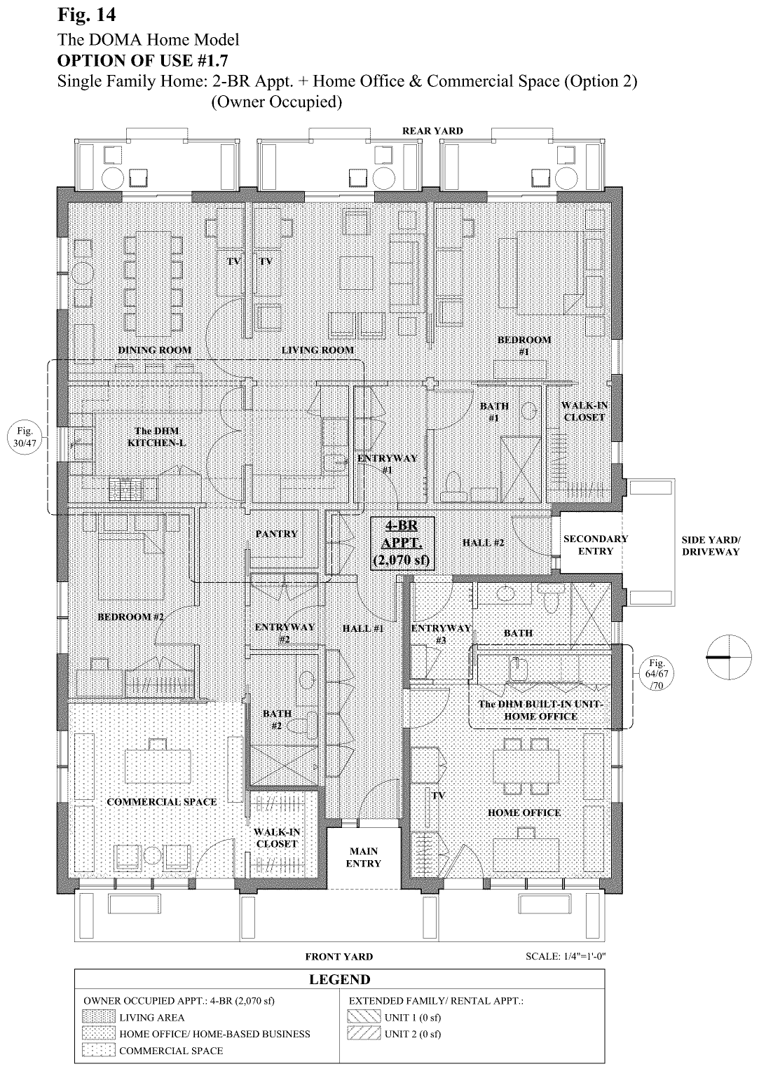

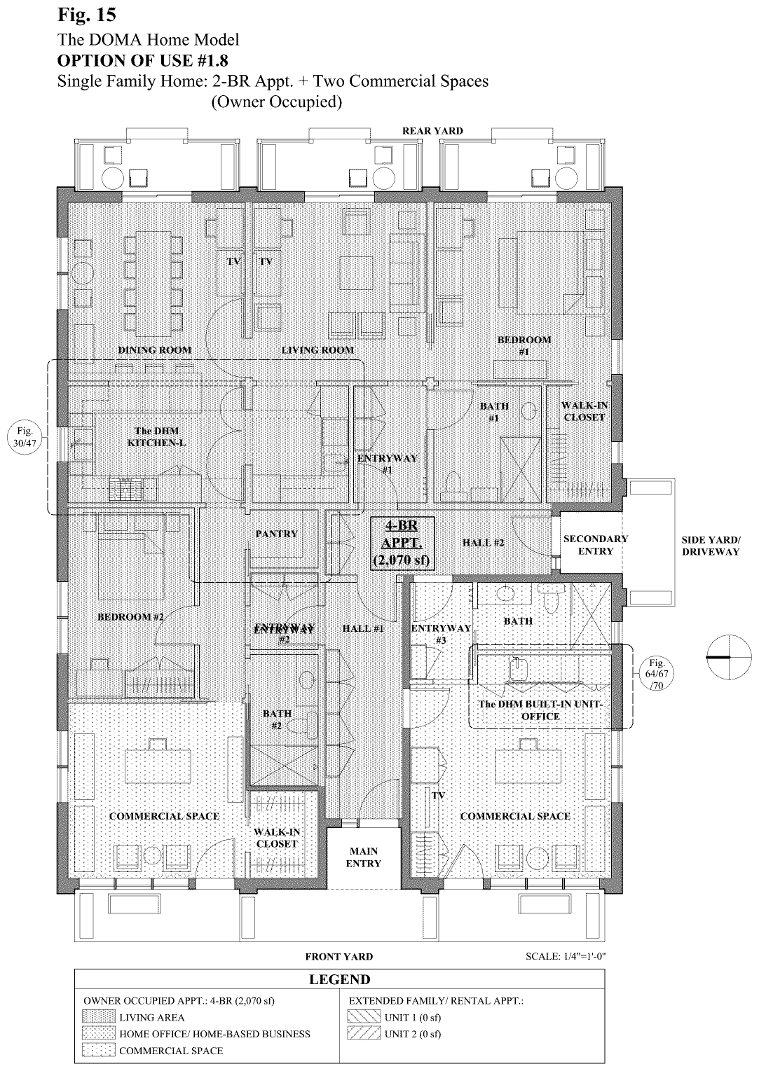

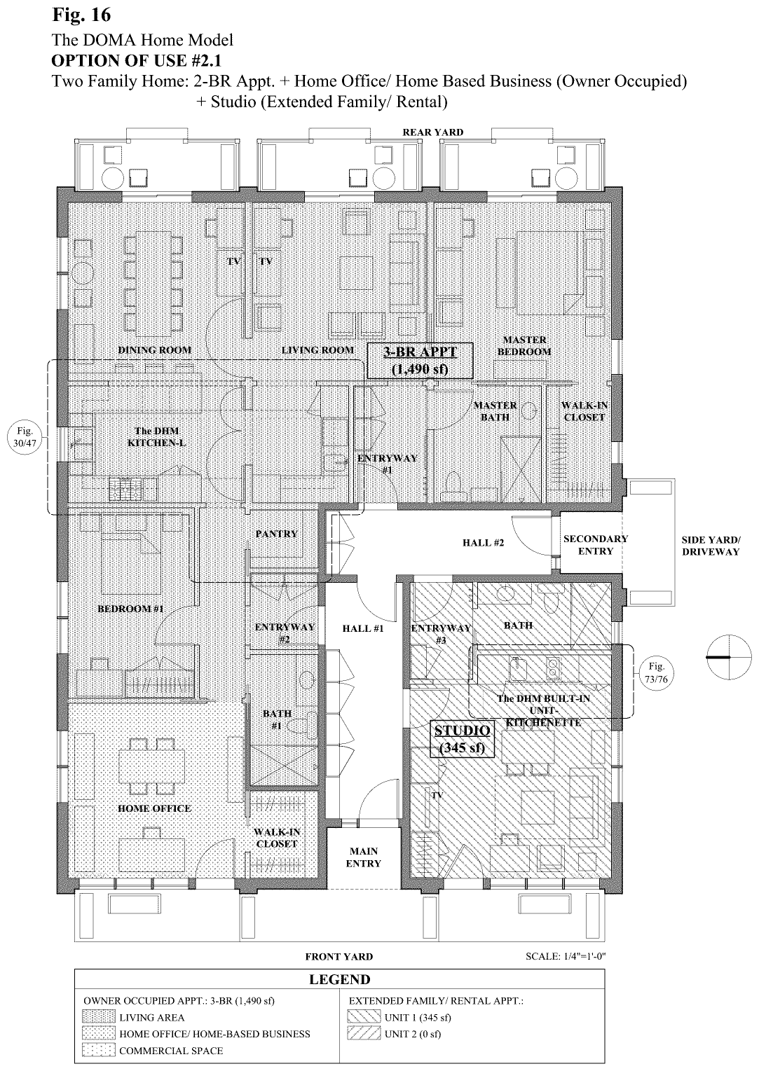

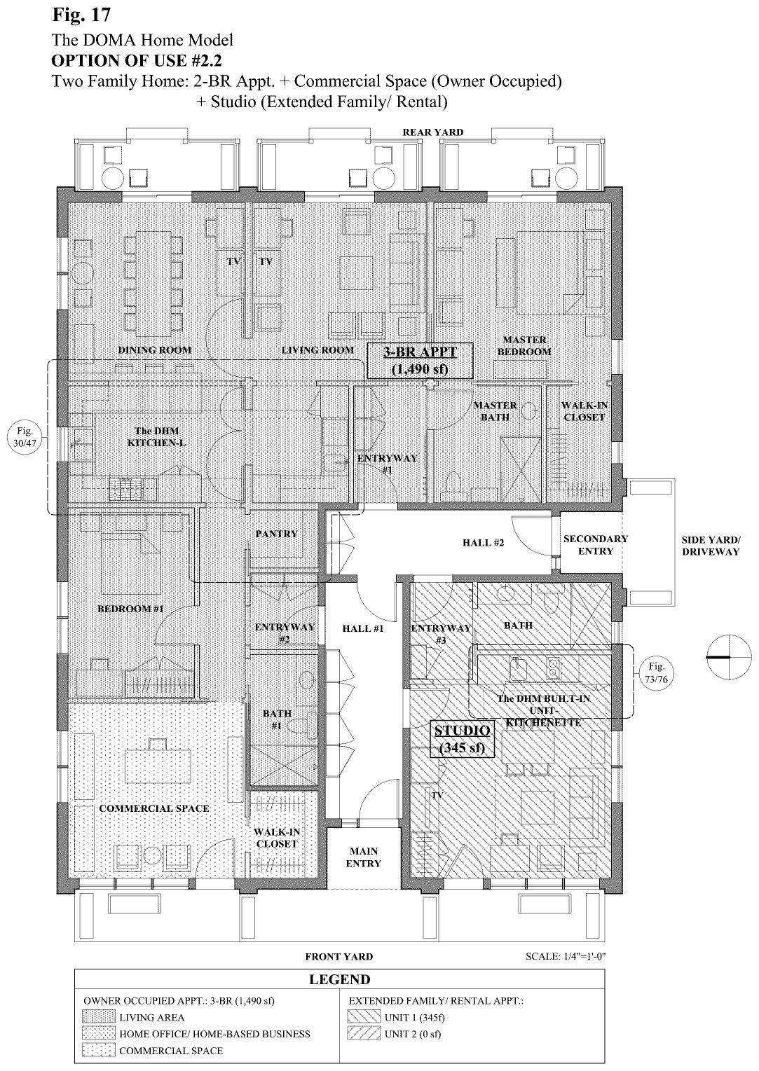

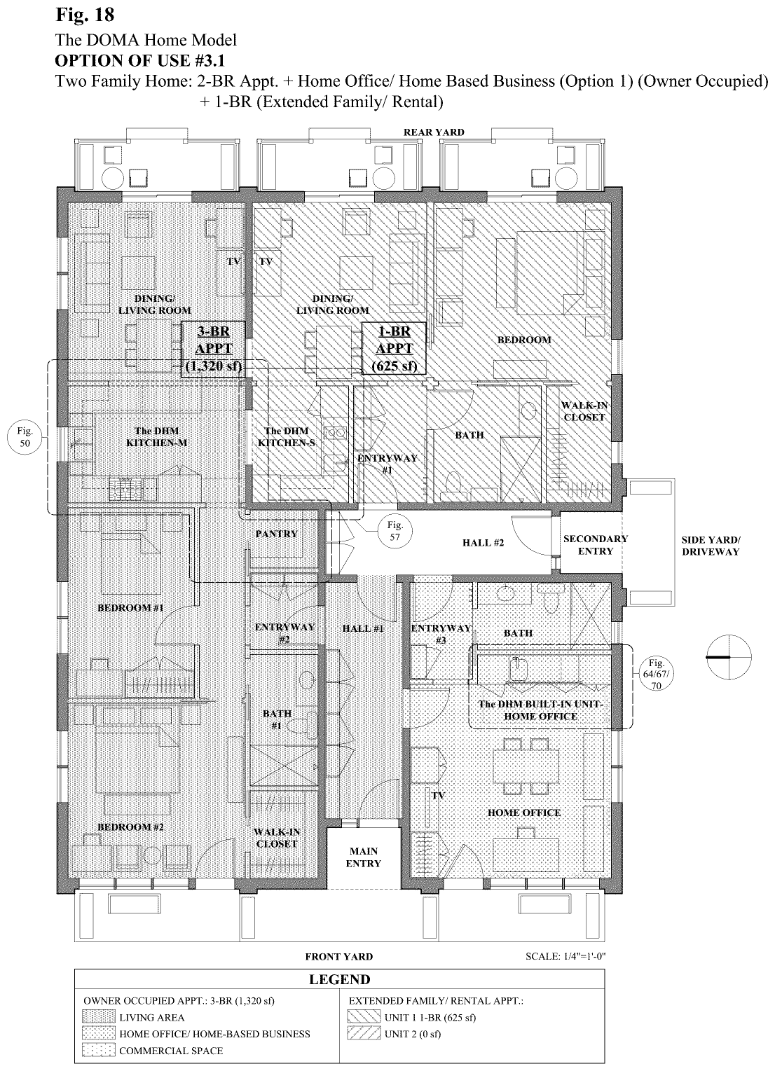

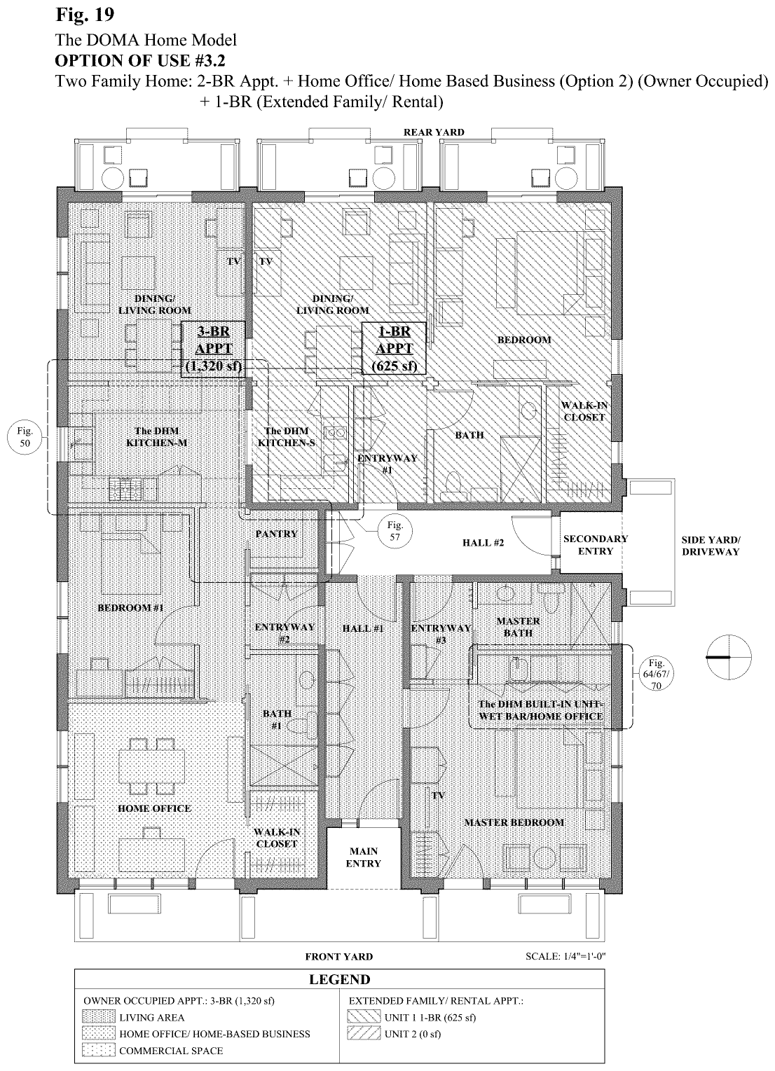

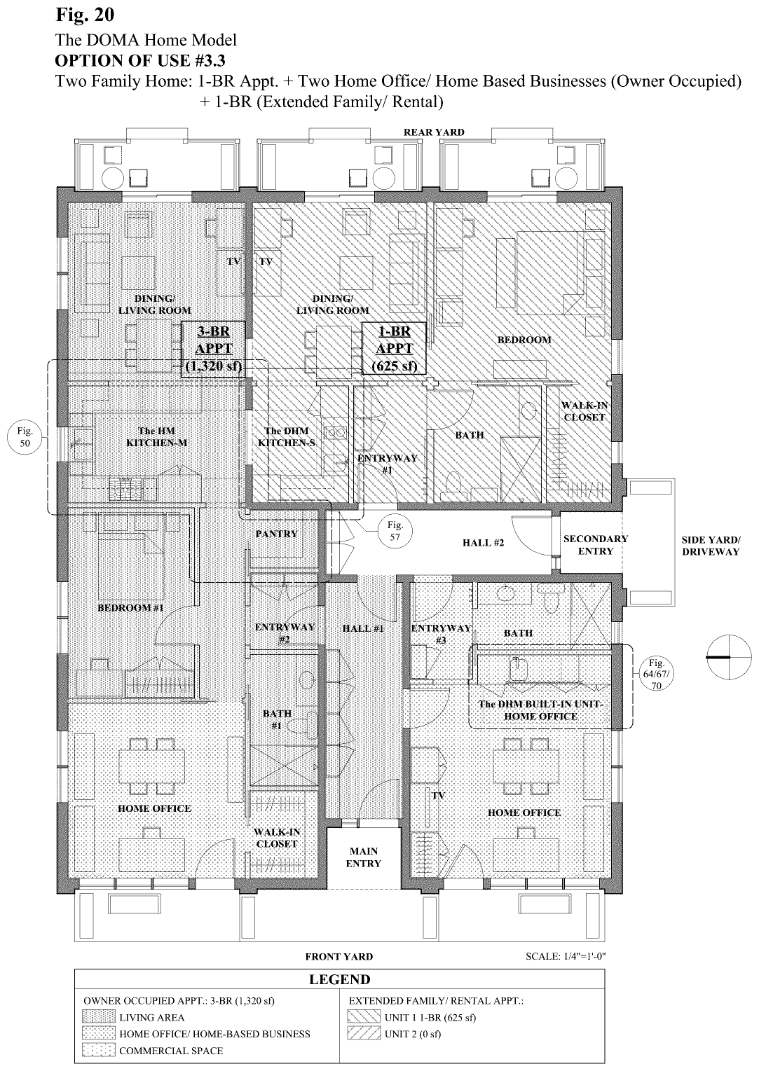

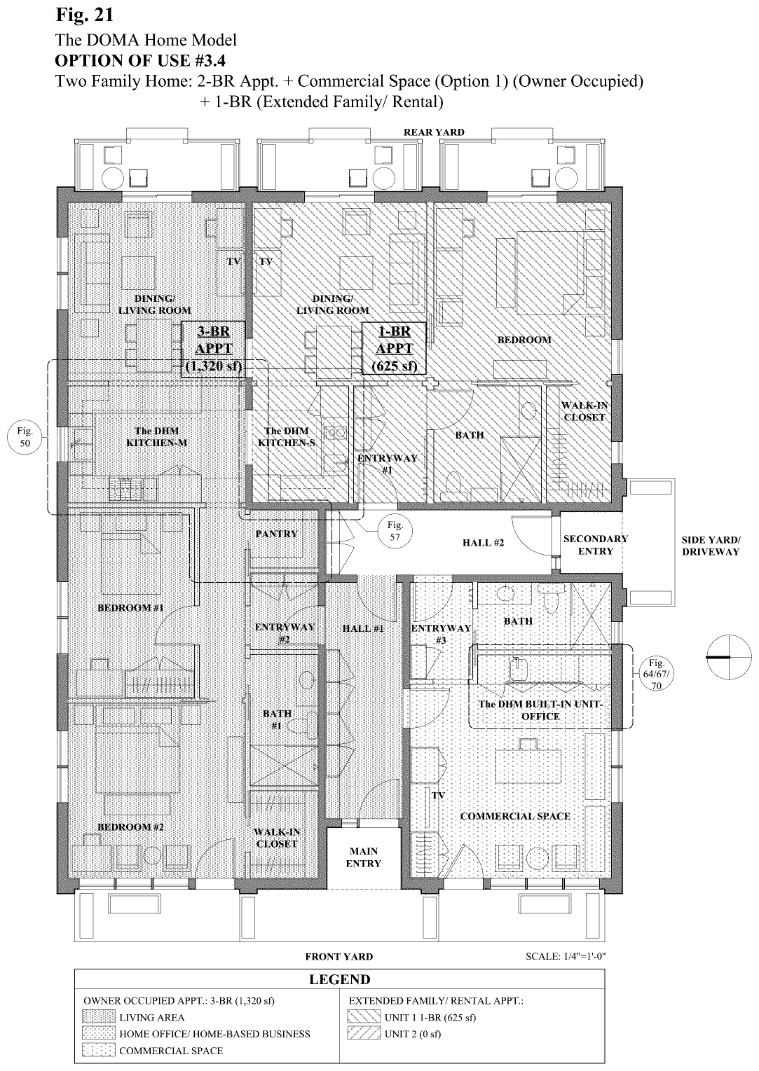

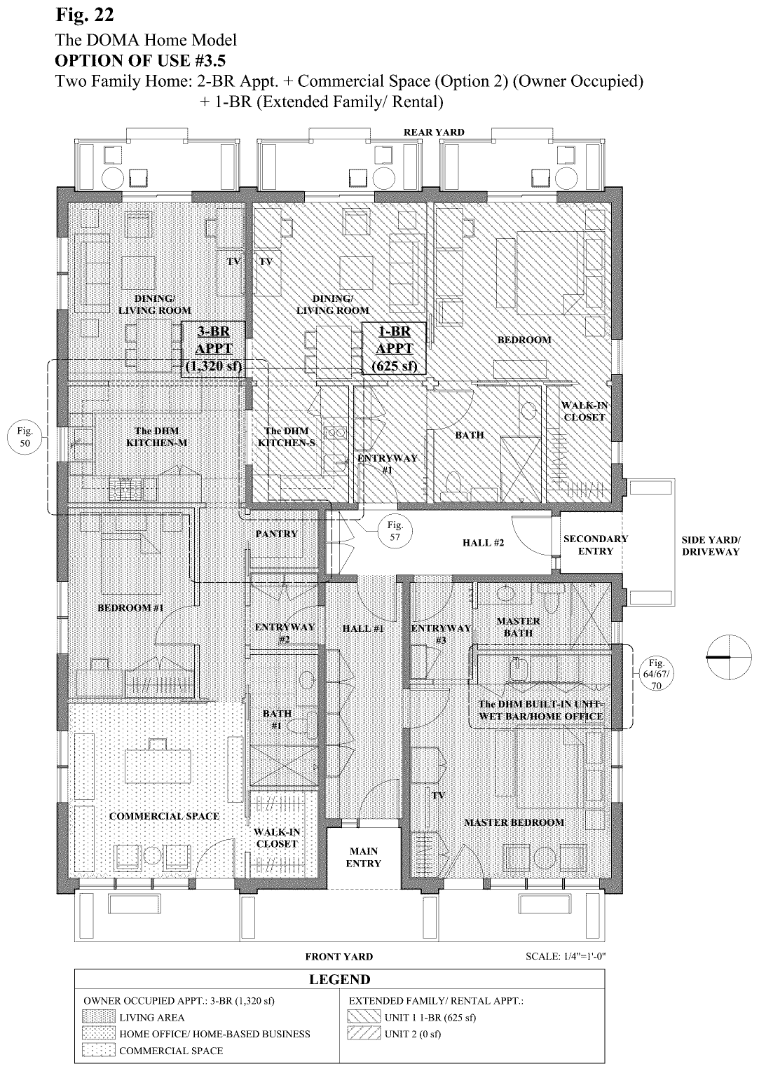

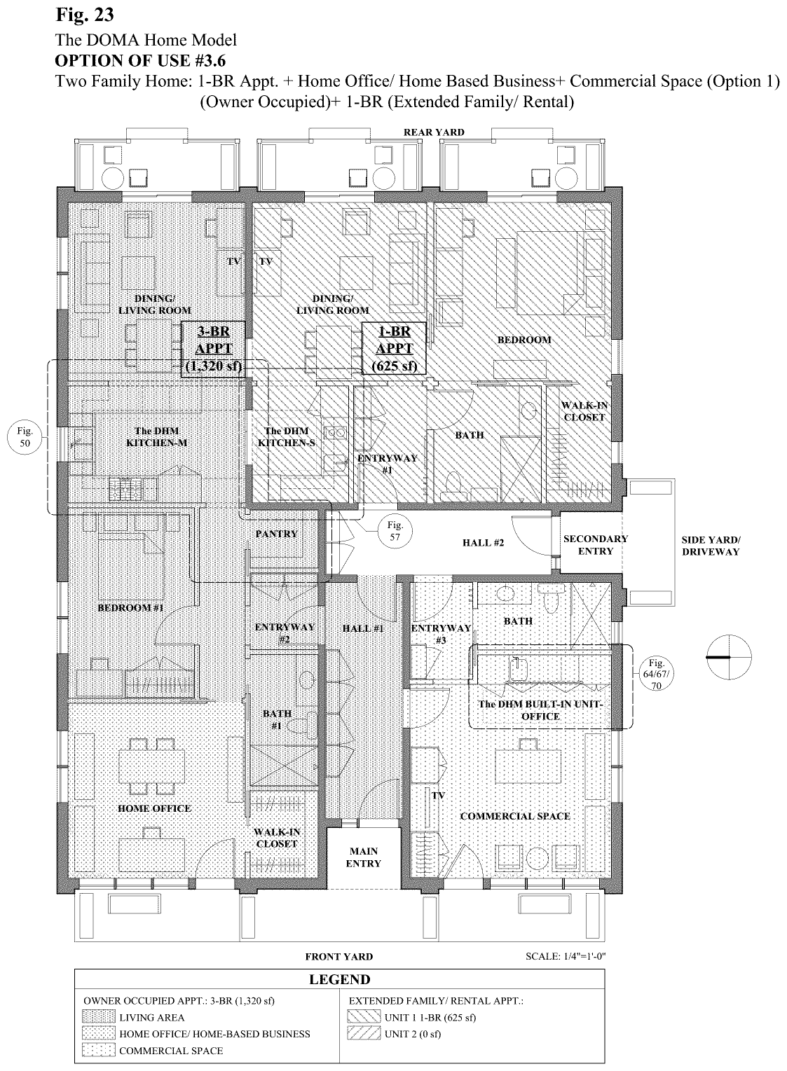

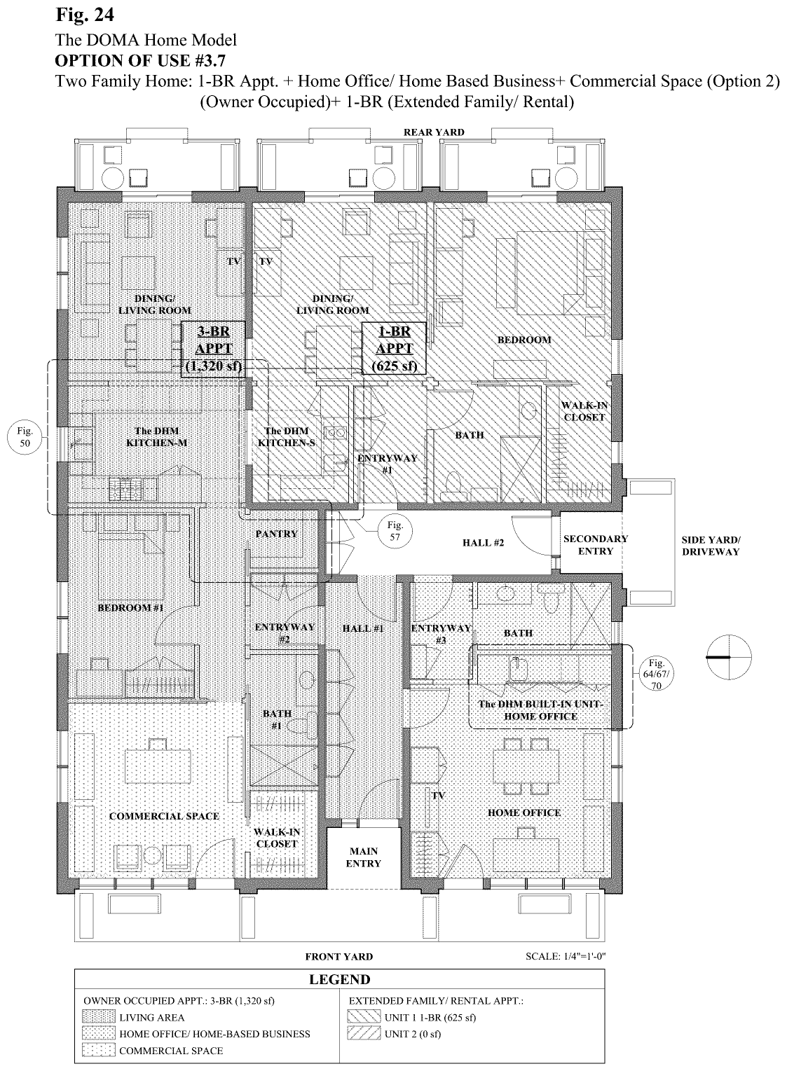

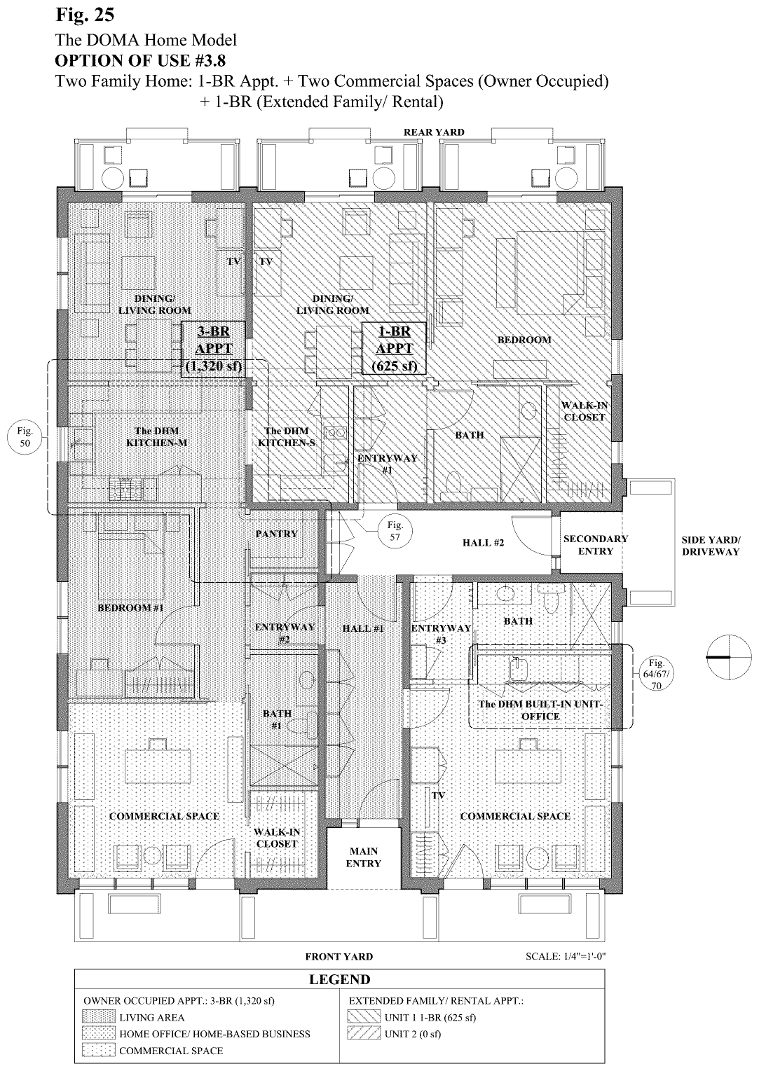

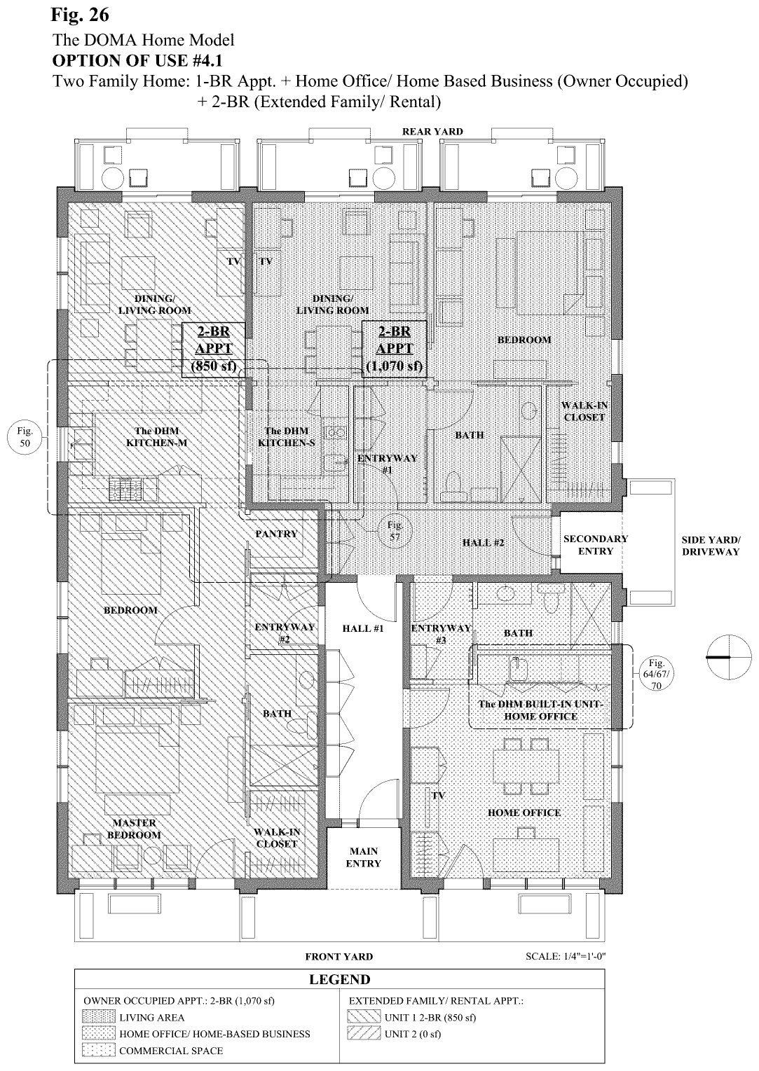

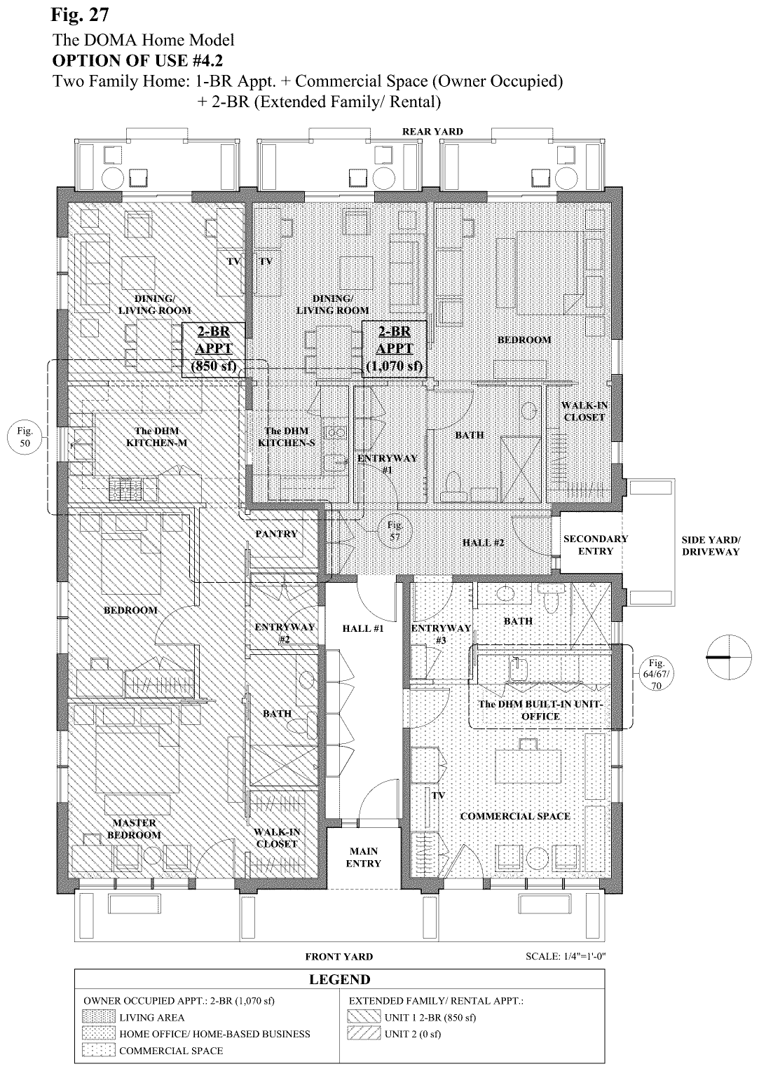

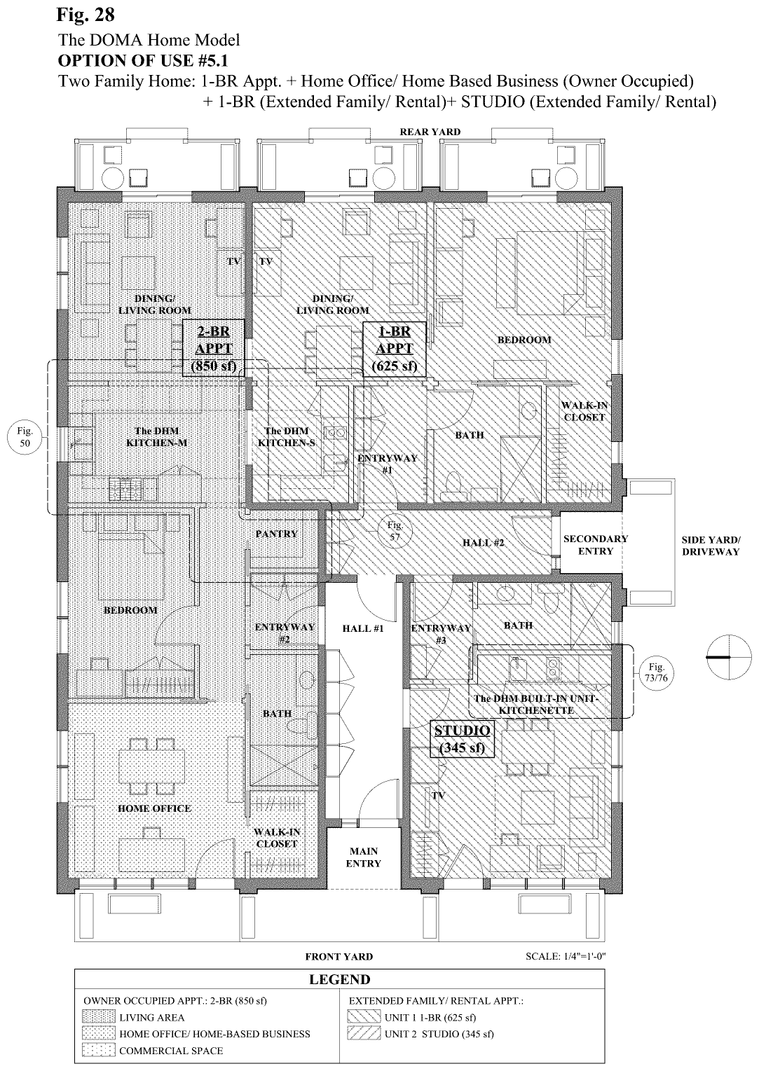

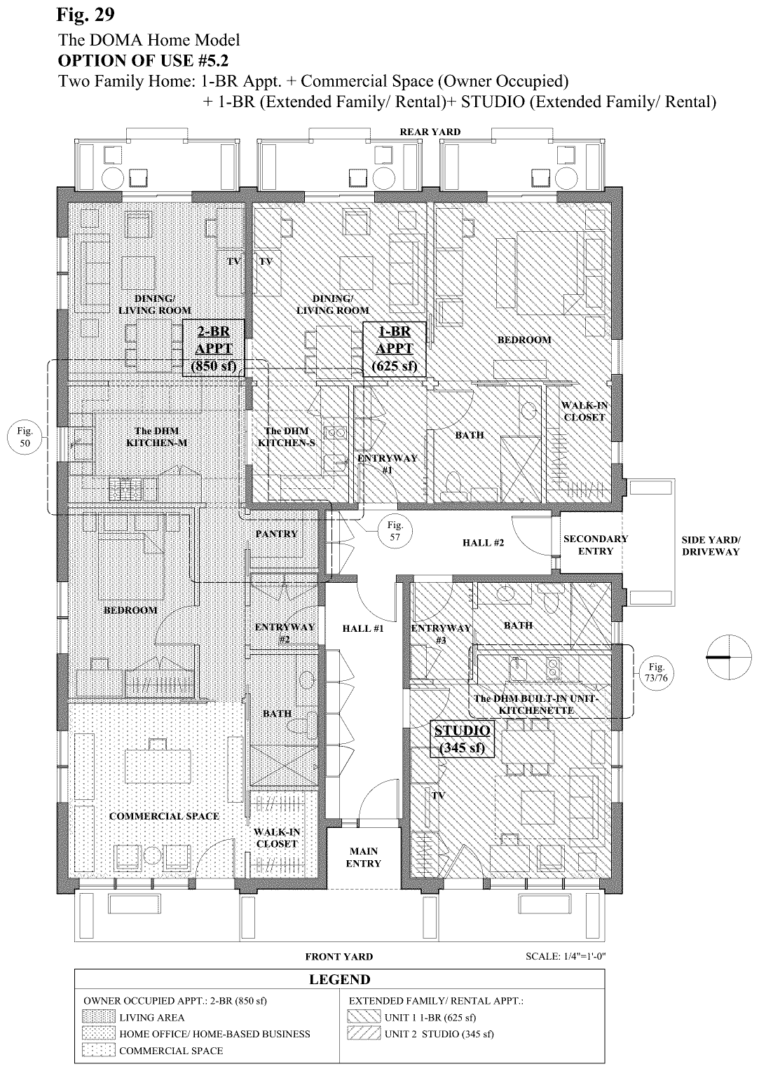

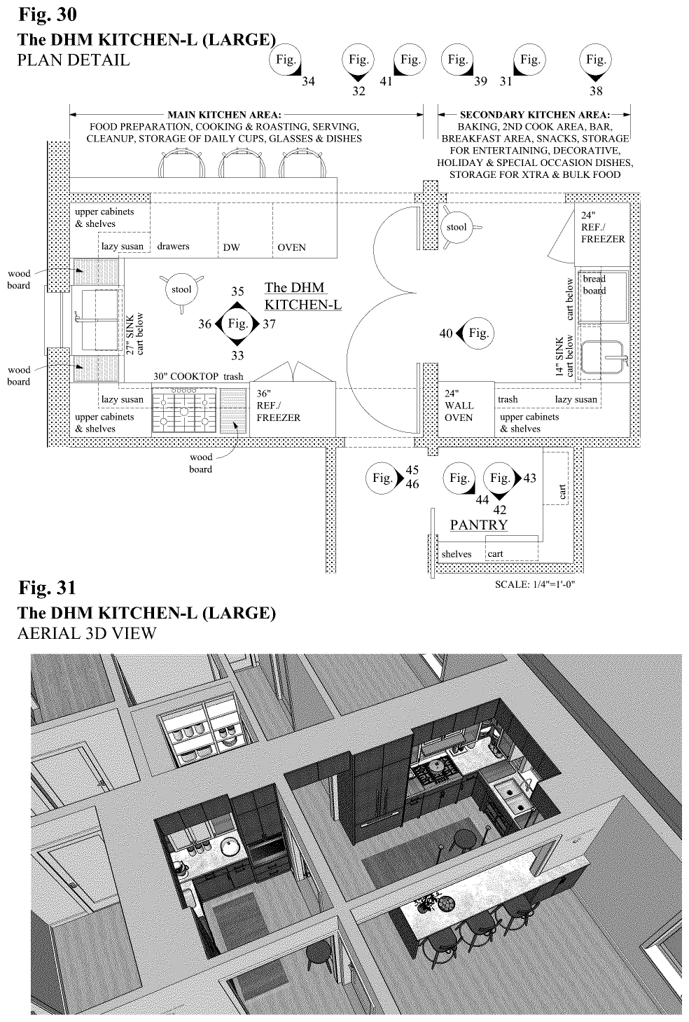

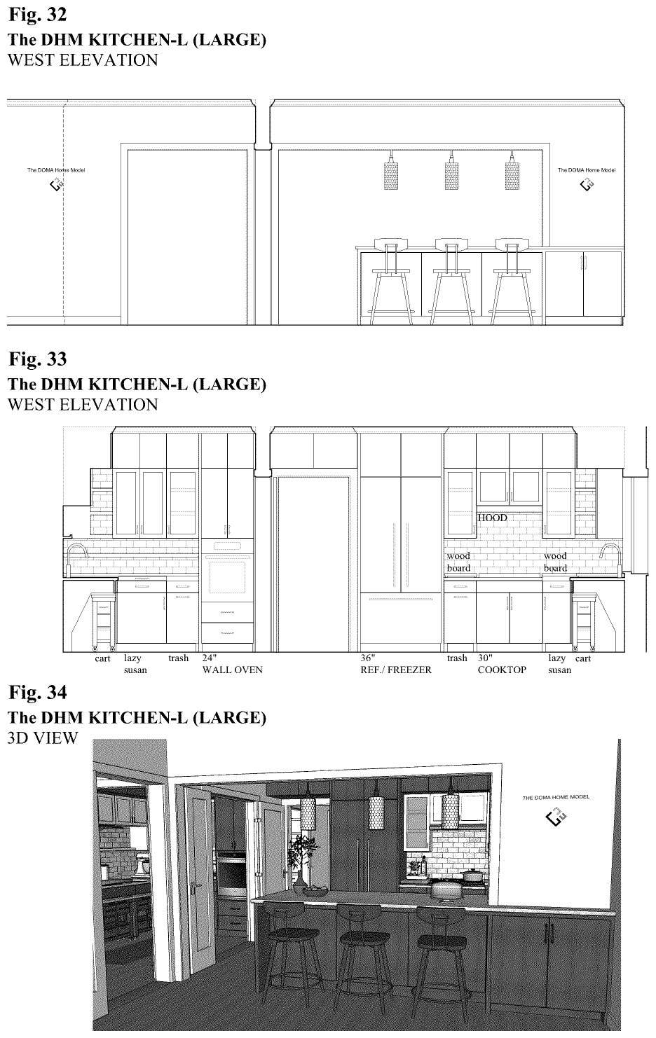

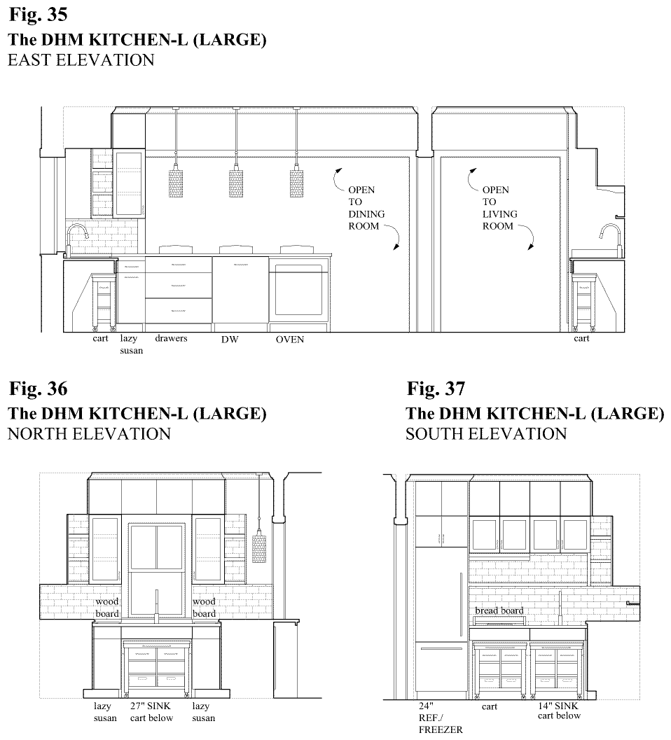

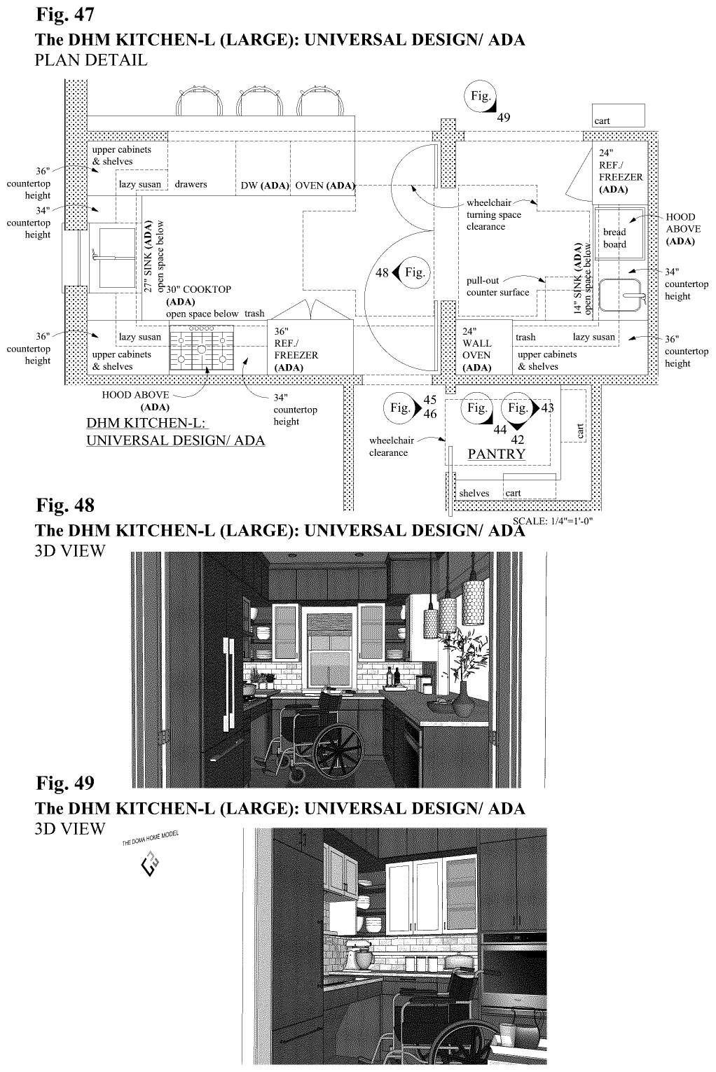

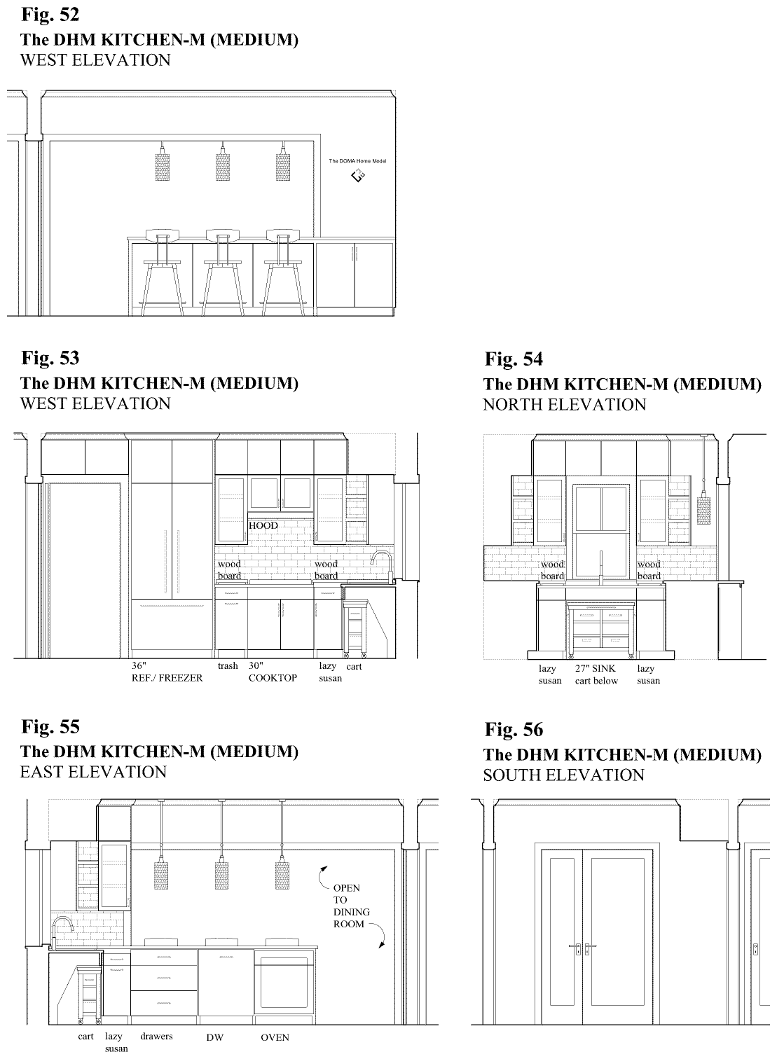

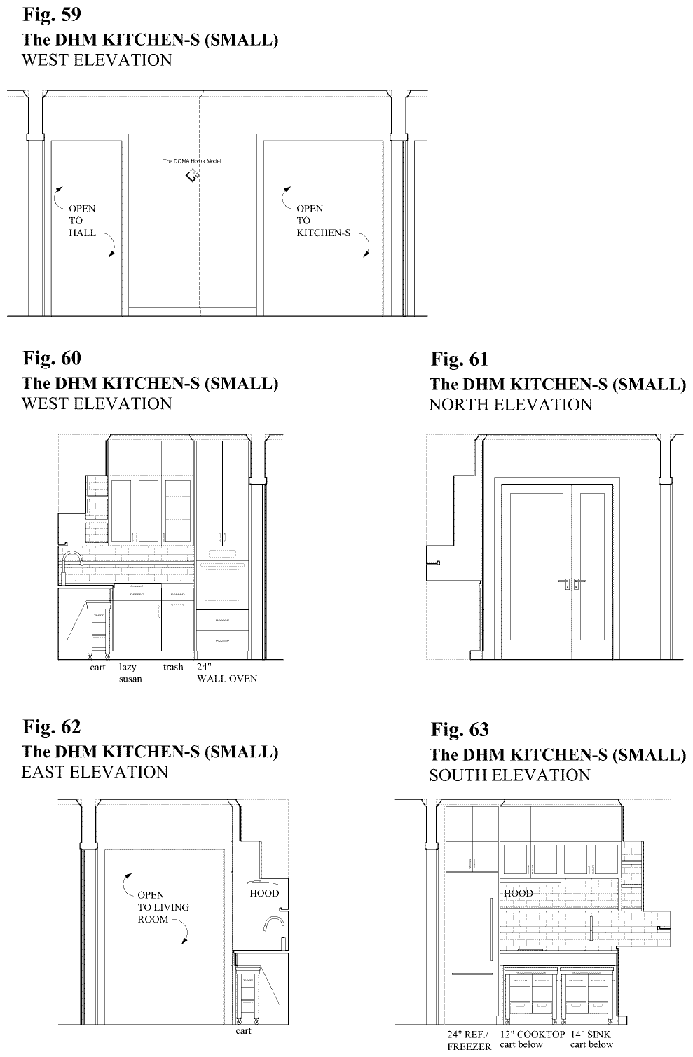

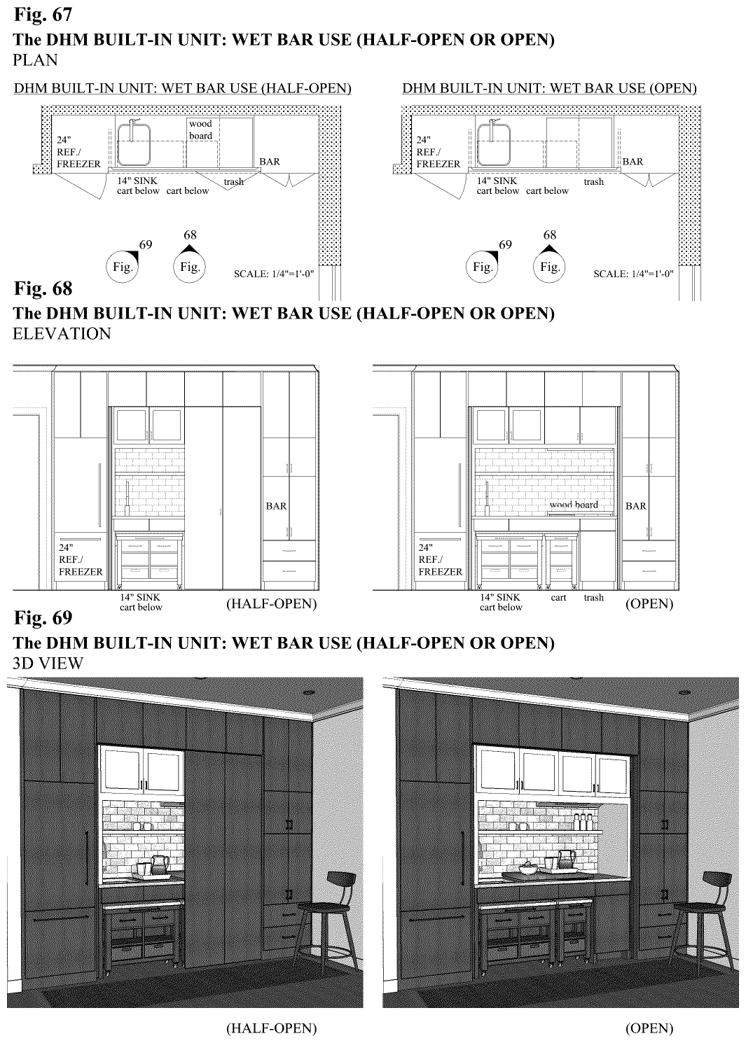

Important design elements of some embodiments, a new hybrid home typology and a specific layout of spaces, hallways, walls and doors, designed for conventional construction with flexibility in use of spaces, are described below. Floor plans, with all options of home use, from option of use #1 through #29, shown on FIG. 1 through 46 have circled and noted two more design elements: a kitchen and a built-in unit with a specific universal/ADA design, designed for conventional construction with flexibility of use as well, all shown in FIGS. 47 through 78.

FIGS. 1 to 29 illustrate floor plans of a first exemplary embodiment for a single ground story free-standing home used in different configurations. FIGS. 30 through 69 describe additional features that may be incorporated into the first exemplary embodiments or other exemplary embodiments.

The first exemplary embodiment is a single dwelling comprising perimeter walls defining an enclosable space and interior walls. The interior walls in combination with the perimeter wall define a kitchen (kitchen-L) having a main kitchen area and a secondary kitchen area separated from the main kitchen area by a first interior wall having a cased opening forming a first interior doorway 1D sized to accommodate at least a single door.

The interior walls in combination with the perimeter walls further define a first multiuse room (e.g., a dining/living room) adjacent to the main kitchen area and connected directly to the main kitchen area, and a second multiuse room (e.g., a dining/living room) adjacent to the secondary kitchen area and connected directly to the secondary kitchen area. The second multiuse room is separated from the first multiuse room by a second interior wall having a cased opening forming a second interior doorway 2D sized to accommodate at least a single door. The first multiuse room, the second multiuse room, and the kitchen forming a living core of the dwelling.

The interior walls in combination with the perimeter walls further define a first bedroom suite adjacent to the core of the dwelling on a first side and separated from the core of the dwelling by a third interior wall having a cased opening forming a third interior doorway 3D sized to accommodate at least a single door, the first bedroom suite including a first bedroom (e.g., bedroom #1) and a first bathroom (e.g., bedroom #2).

The interior walls in combination with the perimeter walls further define a second bedroom suite adjacent to the core of the dwelling on a second side and separated from the core of the dwelling at least in part by a fourth interior wall having a cased opening forming a fourth interior doorway 4D sized to accommodate at least a single door, the second bedroom suite including a second bedroom (e.g., bedroom #2) and a second bathroom (e.g., bathroom ##2). In some embodiments, the second bedroom suite also includes a third bedroom (e.g., bedroom #3). In some embodiments, the second bedroom suite is located at a ground floor of the dwelling, and the third bedroom faces a front of the dwelling at a height accessible from the street and has an exterior entrance.

The interior walls in combination with the perimeter walls further define a first hall (e.g., hall #1) connecting at a first end with a main entry of the dwelling and separated from the second bedroom suite by a fifth interior wall having a cased opening forming a fifth interior doorway 5D sized to accommodate at least a single door.

The interior walls in combination with the perimeter walls further define a second hall (e.g., hall #2) connecting at a first end with a secondary entry of the dwelling, a second end of the first hall separated from the second hall by a sixth interior wall having a cased opening forming a sixth interior doorway 6D sized to accommodate at least a single door. The second hall is separated from the first bedroom suite by a seventh interior wall having a cased opening forming a seventh interior doorway 7D sized to accommodate at least a single door and providing access to the first bedroom suite and the second multipurpose room.

The interior walls in combination with the perimeter walls further define a master suite including a master bedroom and a master bathroom. The master suite is separated from the first bedroom suite by the first hall and separated from the second bedroom suite by the second hall. An eighth interior wall separating the first hallway and the master suite has a cased opening forming an eighth interior doorway 8D sized to accommodate at least a single door. An internal wall separating the second hallway and the master bedroom suite has a cased opening forming a ninth interior doorway 9D sized to accommodate at least a single door and providing access to the master bedroom suite.

The dwelling is configured for flexible use as one unit, two units, and three units based on securing doors in one or more of the first interior doorway and the second interior doorway, and based on using fire rated and lockable doors in one or more of the first interior doorway, second interior doorway, fifth interior doorway, sixth interior doorway, seventh interior doorway, eighth interior doorway, and ninth interior doorway.

The single dwelling is suitable for use as a single family home having at least three bedrooms as illustrated in FIG. 1.

With lockable and fire rated doors in the first interior doorway, second interior doorway, sixth interior doorway, seventh interior doorway, and ninth interior doorway, and with the lockable and fire rated doors in the first interior doorway and second interior doorway secured, the single dwelling is suitable for use as a two family home including: a first apartment comprising the first multipurpose room, the main kitchen area (e.g., kitchen-M), the second bedroom suite, the first hall, and the master suite, and a second apartment comprising the second multipurpose room, the secondary kitchen area (e.g., kitchen-S) and the first bedroom suite as illustrated in FIG. 3.

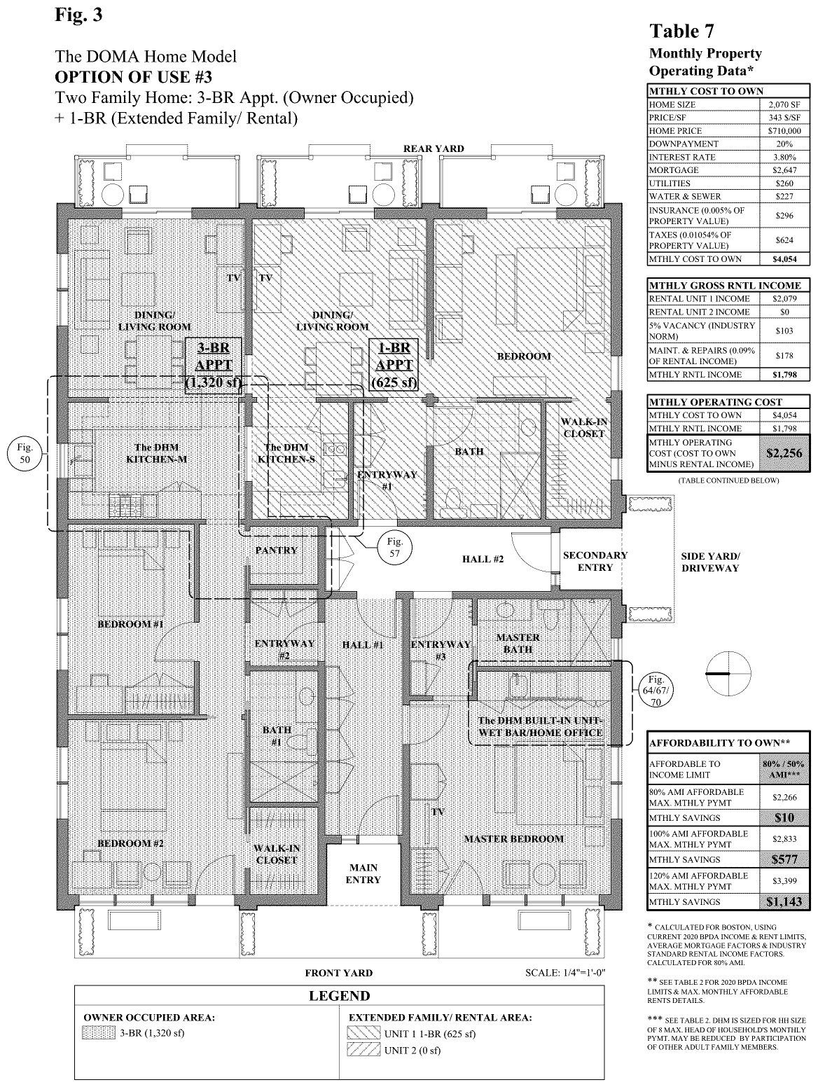

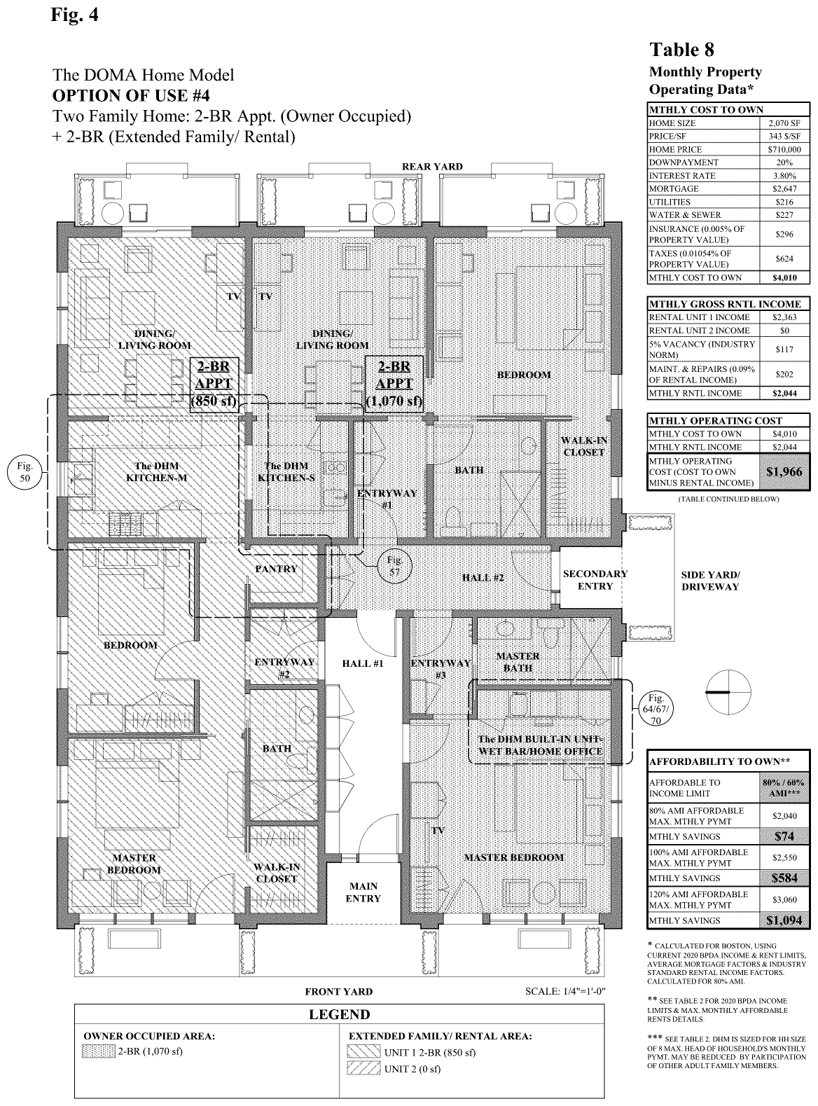

With lockable and fire rated doors in the first interior doorway, second interior doorway, and sixth interior doorway, and with the lockable and fire rated doors in the first interior doorway and second interior doorway secured, the single dwelling is suitable for use as a two family home including: a first apartment comprising the first multipurpose room, the main kitchen area (e.g., kitchen-M), and the second bedroom suite; and a second apartment comprising the second multipurpose room, the secondary kitchen area (e.g., kitchen-S), the first bedroom suite, the second hall, and the master bedroom suite as illustrated in FIG. 4.

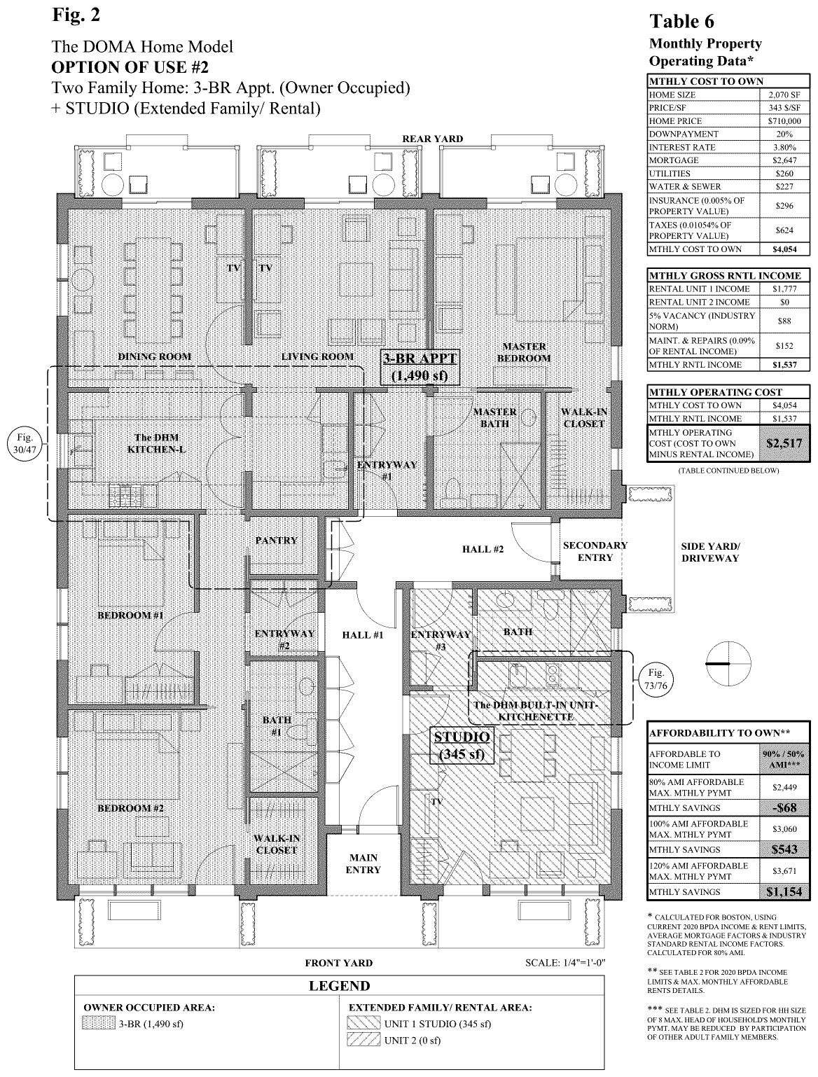

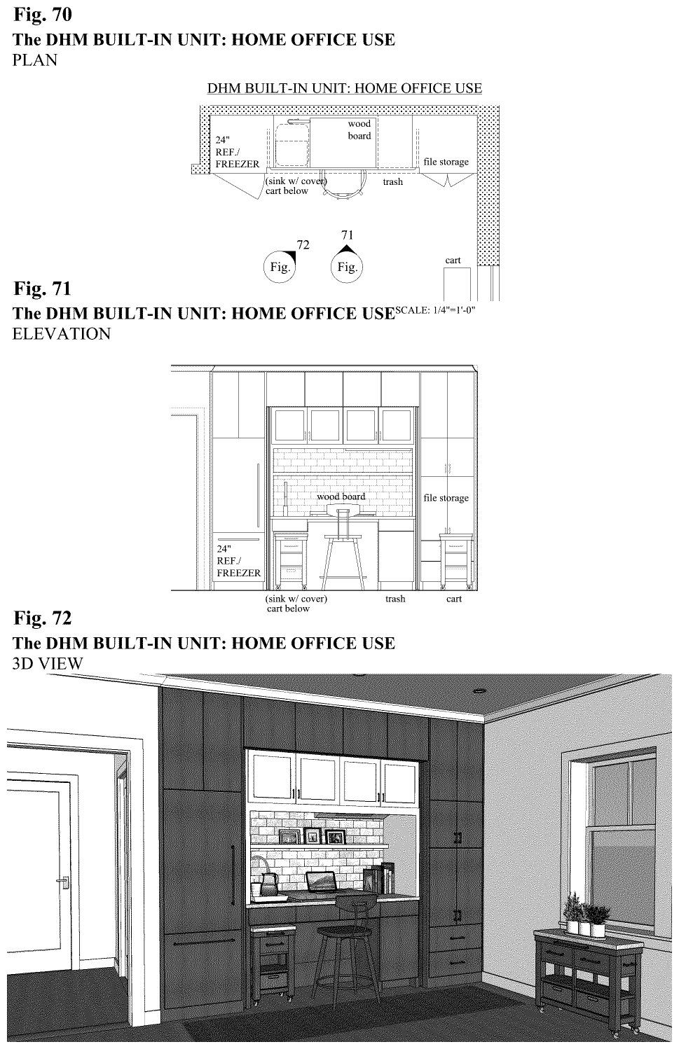

In some embodiments, the master suite is configured with a built-in unit for functioning as a kitchen or kitchenette as illustrated in FIGS. 70 through 75. In some embodiments in which the master suite is configured with a kitchen or kitchenette, with lockable and fire rated doors in the sixth interior doorway, seventh interior doorway, and ninth interior doorway, the single dwelling is suitable for use as a two family home including: a first apartment comprising the first multipurpose room, the second multipurpose room, the kitchen (e.g., kitchen-L), the first bedroom suite, and the second bedroom suite; and a second apartment comprising the master bedroom suite as illustrated in FIG. 2.

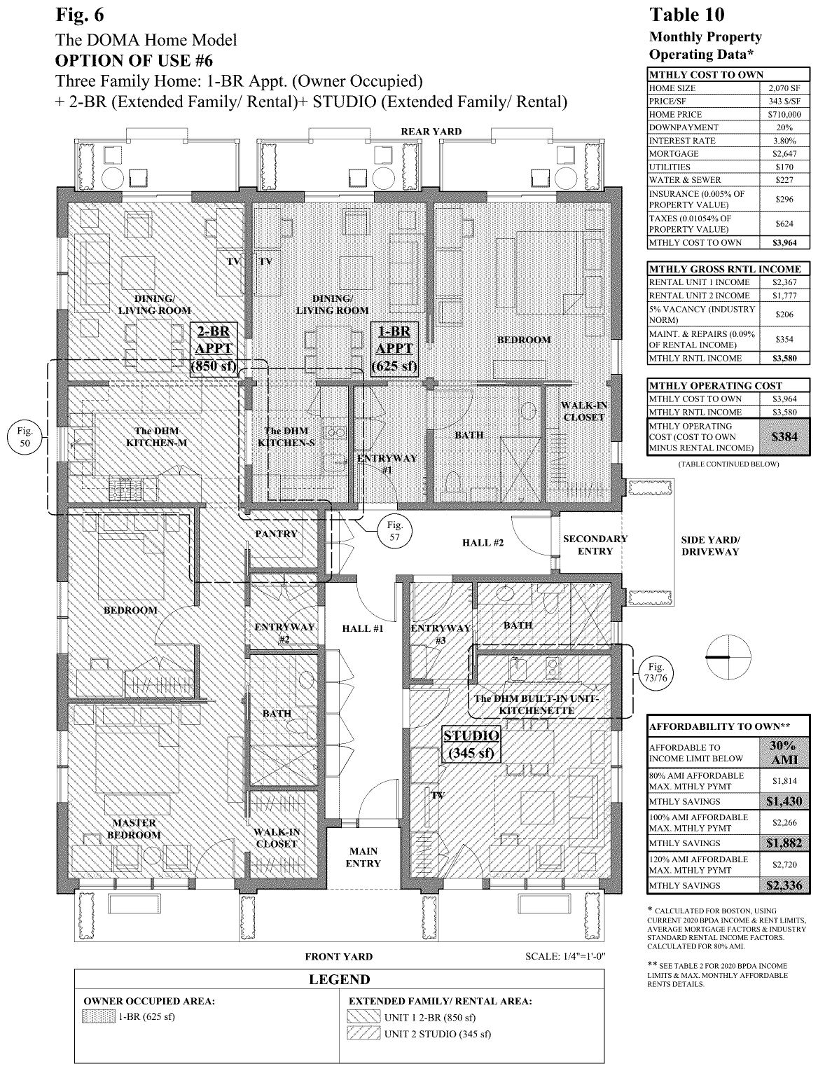

With doors in the first interior doorway and in the second interior doorway secured, and with doors in the fifth interior doorway, the seventh interior doorway, the eighth interior doorway, and the ninth interior doorway suitable as outer apartment doors, the single dwelling is suitable for use as a three family home including: a first apartment comprising the first multipurpose room, the main kitchen area (e.g., kitchen-M), and the second bedroom suite; and a second apartment comprising the second multipurpose room, and secondary kitchen area, and the first bedroom suite; and a third studio apartment comprising the master bedroom suite as illustrated in FIG. 6.

In some embodiments, the first bedroom suite is adjacent to the second multipurpose room. In some embodiments, the second bedroom suite is adjacent to the kitchen (e.g., kitchen-L). In some embodiments, the first bedroom suite also includes a first entryway (e.g., entryway #2) providing access to the second hall through the seventh interior doorway. In some embodiments, the second bedroom suite also includes a second entryway (e.g., entryway #2) providing access to the first hall through the through the fifth interior doorway. In some embodiments, the master suite also includes a third entryway (e.g., entry #3) providing access to the second hall through the ninth interior doorway.

In some embodiments, the first multipurpose room and the second multipurpose room are each sized and dimensioned to function as living room and as a dining room.

In some embodiments, the first kitchen area and second kitchen area are each configured to function as an independent kitchen and to function collectively as a single kitchen. In some embodiments, the first interior doorway 1D between the first kitchen area and the second kitchen area corresponds to a wide double door. In some embodiments, the dwelling further comprises a wide double door in the first interior entryway. In some embodiments, the wide double door is sized and configured to lean against the first interior wall in a wide-open position.

FIGS. 30 to 41 and 47 to 49 illustrate additional features of the main kitchen area in some example embodiments. In some embodiments, the main kitchen area includes a main sink area and a main cooktop area. In some embodiments, the dwelling further comprises counters in the main kitchen area with countertops at a height of 34 inches in a first portion of the main kitchen area adjacent to the main sink on a first side, in a second portion of the main kitchen area adjacent to main sink on a second side, and a third portion adjacent to the main cooktop area, and countertops in the rest of the main kitchen area having a height of 36 inches. In some embodiments, the dwelling further comprises first set of removable elements (e.g., wood blocks) having a height of about two inches and configured to cover the countertops with the height of 34 inches in the first portion, second portion, and third portion of the main kitchen area. In some embodiments, the dwelling further comprises bottom cabinets in the main sink area and the main cooktop area. The bottom cabinets in the main sink area and the main cooktop area are either fully open with no doors, or have removable doors. In some embodiments, the bottom cabinets are least 30 inches wide clear to allow for wheelchair use. In some embodiments, the dwelling further comprises upper cabinets in the main kitchen area at a height of 52 inches above the floor.

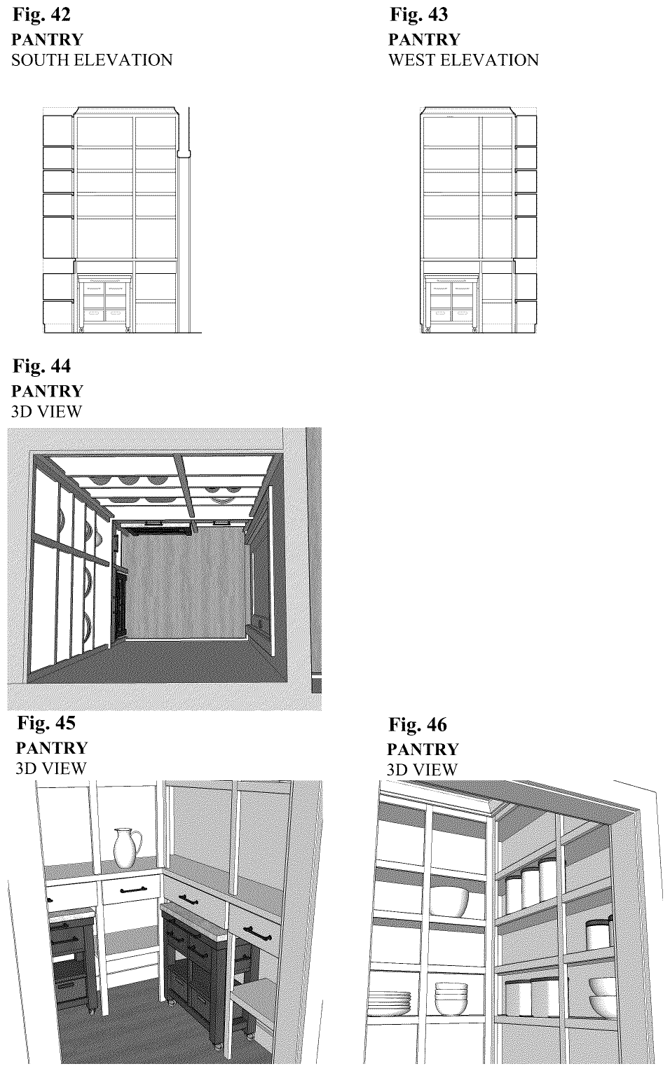

FIGS. 42 to 46 illustrate pantry that may be included in the dwelling in accordance with some embodiments. The pantry may be included in the living core of the dwelling.

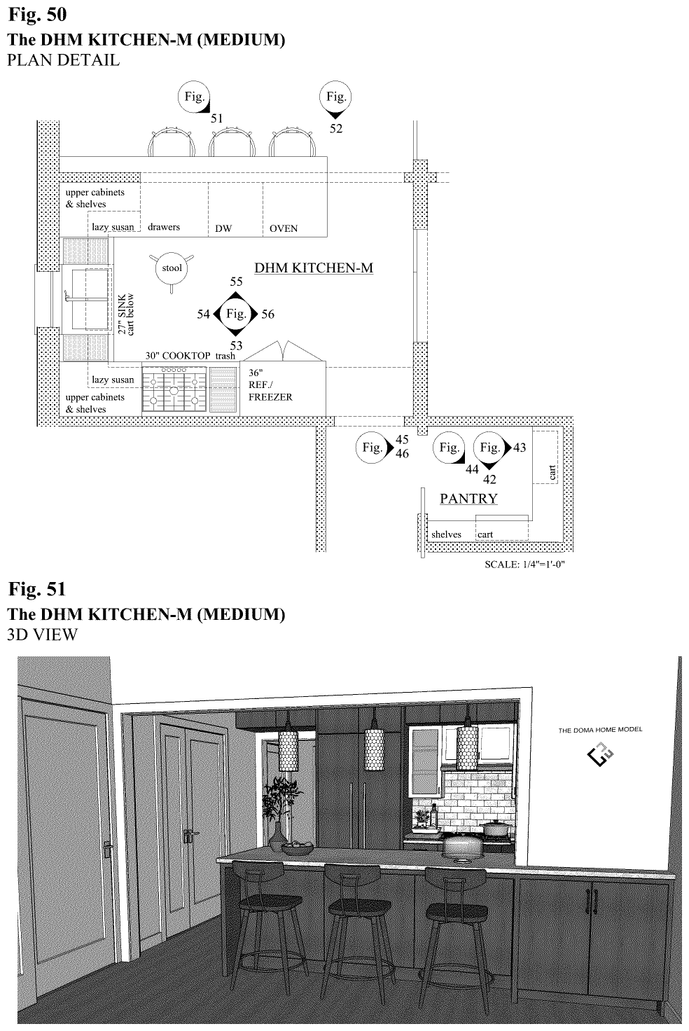

FIGS. 50 to 63 illustrate additional features of the secondary kitchen area in some example embodiments. In some embodiments, the dwelling includes counters in the secondary kitchen area with countertops at a height of 34 inches in a first portion of the secondary kitchen area adjacent to the secondary sink on a first side, in a second portion of the secondary kitchen area adjacent to the secondary sink on a second side, and a third portion adjacent to the secondary cooktop area, and countertops in the rest of the secondary kitchen area having a height of 36 inches. In some embodiments, the dwelling further includes a second set of removable elements (e.g., wood blocks) in the secondary kitchen area having a height of about two inches and configured to cover the countertops with the height of 34 inches in the first portion, second portion, and third portion of the secondary kitchen area. In some embodiments, the dwelling further includes bottom cabinets in the secondary sink area and secondary cooktop area, the bottom cabinets in the secondary sink area and the secondary cooktop area either fully open with no doors, or with removable doors, the bottom cabinets at least 30 inches wide clear to allow for wheelchair use. In some embodiments, the dwelling further includes upper cabinets in the secondary kitchen area at a height of 52 inches above the floor.

In some embodiments, the master bedroom is located at a ground floor of the dwelling, faces a front of the dwelling at a height accessible from a street and has an exterior entrance. In some embodiments, the master bedroom is located at a ground floor of the dwelling and has an exterior entrance.

In some embodiments, hall sizes, door widths, and locations, sizes and spacings in the living core, the first bedroom suite, the second bedroom suite, and the master bedroom suite are consistent with handicap entry passage and use per ADA group 1. In some embodiments, the first bedroom suite is dimensioned for ADA group 2 accessibility and the secondary kitchen area is dimensioned for ADA group 2 accessibility.

In some embodiments, a perimeter of the dwelling has a first diagonal length and a second diagonal length, and the main entry and the secondary entry are separated by a distance that is at least one third of the shorter of the first diagonal length and the second diagonal length.

In some embodiments, a perimeter of the master suite has a third diagonal length and a fourth diagonal length, and the eighth interior doorway and the ninth interior doorway are separated by a distance that is at least one third of the shorter of the third diagonal length and the fourth diagonal length.

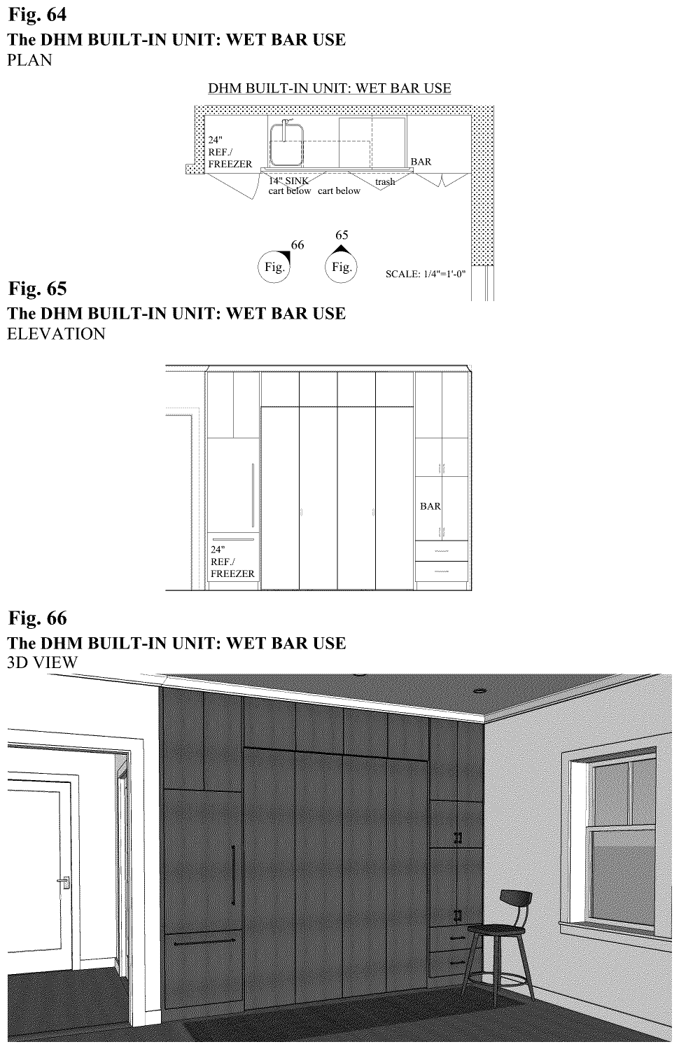

In some embodiments, dwelling further comprises built-in unit in the master suite (see FIGS. 64 to 79). The built-in unit includes: a central portion including countertop and a sink; a first end portion including a first cabinet configured to house a refrigerator, a freezer, both, or a combination refrigerator and freezer; a second end portion including a second cabinet with one or more drawers; and an upper portion including a third upper cabinet over the central portion between the first end portion and the second end portion. In some embodiments, the built-in unit includes full panel folding doors configured to cover the central portion when fully closed, each full panel folding door configured to slide into a side pocket when fully open. In some embodiments, a depth of the first cabinet, the second cabinet, and the third cabinet are such that the full panel folding doors are flush with doors of the first cabinet, the second cabinet and the third cabinet when the full panel folding doors are closed. In some embodiments the built-in unit further comprises removable undercounter face panels. In some embodiments, the sink of the built-in unit is flush with the countertop of the central portion of the built-in unit. In some embodiments, the sink of the built-in unit has a faucet configured to be rotated to an orientation parallel with a back wall of the built-in unit. In some embodiments, the central portion of the built-in unit also includes a third cabinet including a drawer and a panel door. In some embodiments, the central portion of the built-in unit also includes an electric cooktop flush with the central portion countertop and a hood above the electric cooktop. In some embodiments, the built-in unit also includes a removable element (e.g., a wood block) configured to cover the flush electric cooktop and function as a desktop when covering the flush electric cooktop. In some embodiments, the second cabinet of the built-in unit is configured to house a wall oven. In some embodiments, the one or more drawers of the second cabinet are dimensioned to be used as filing drawers.

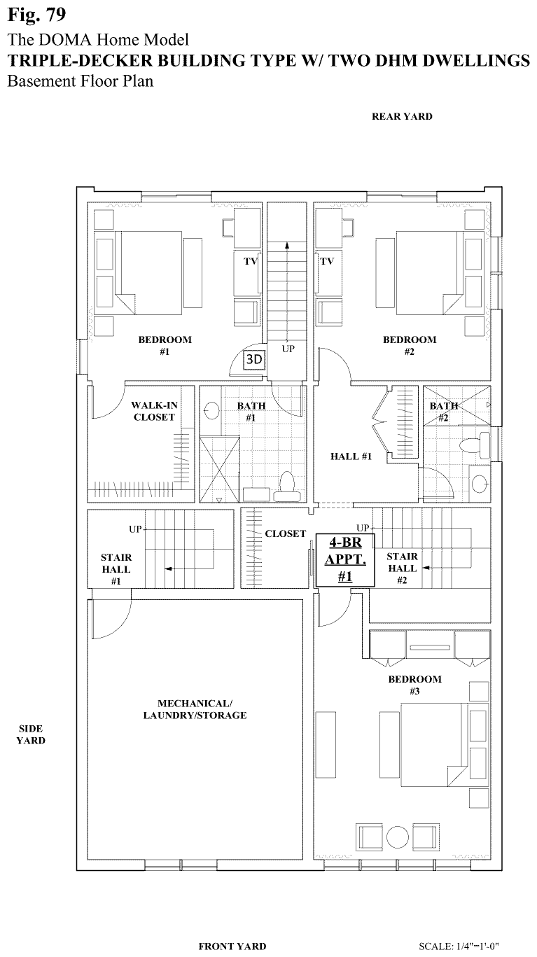

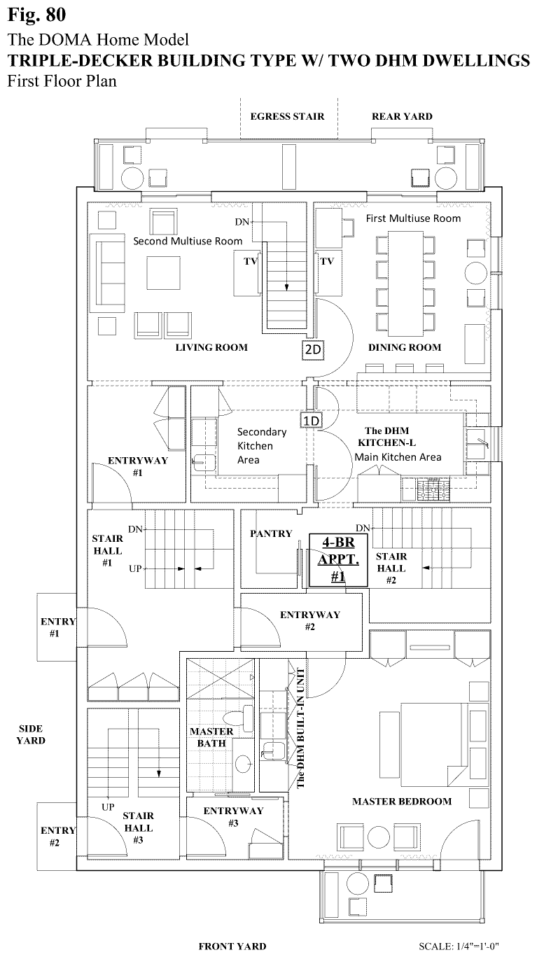

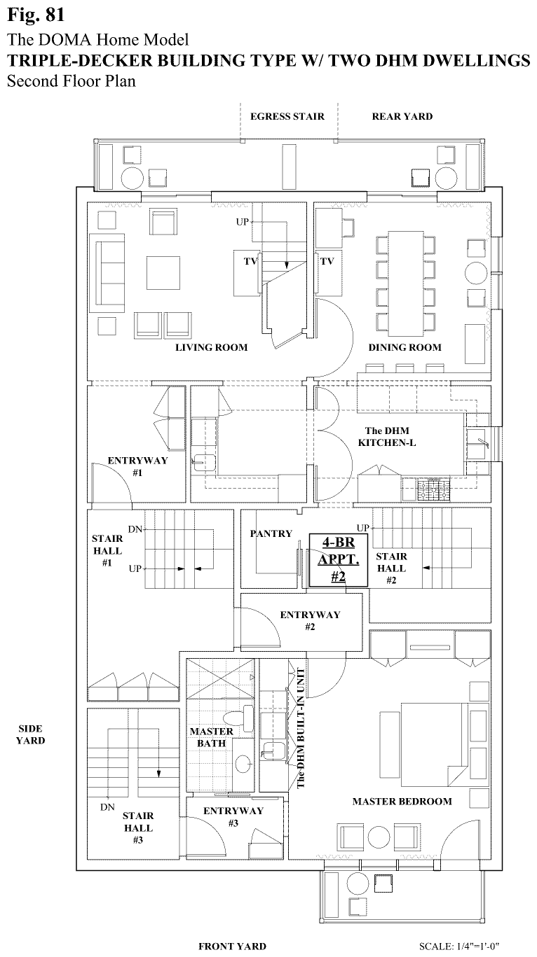

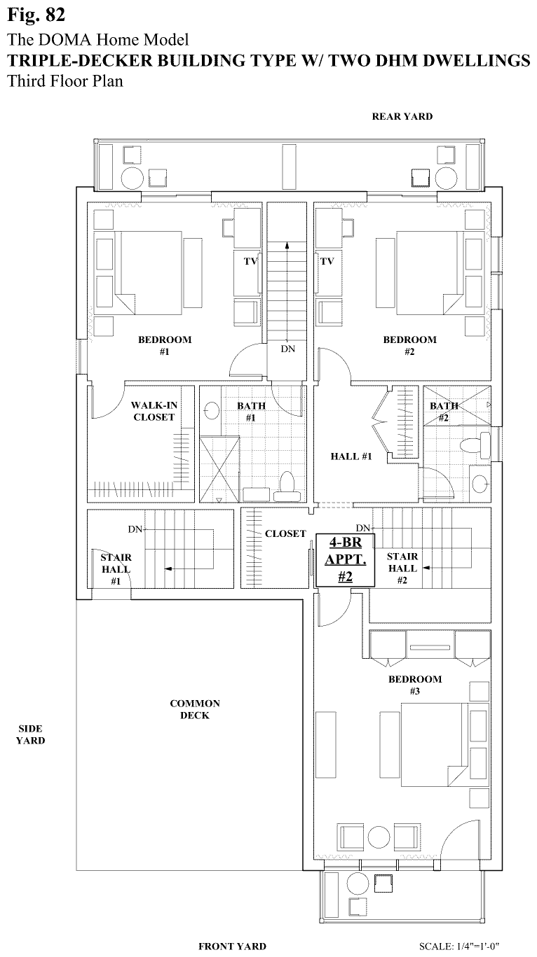

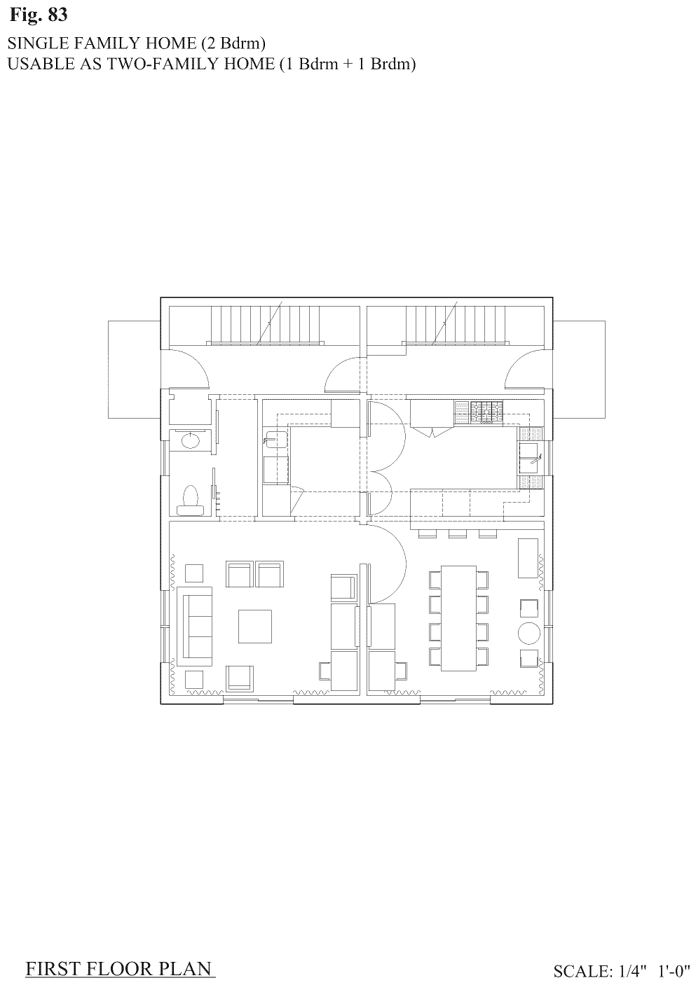

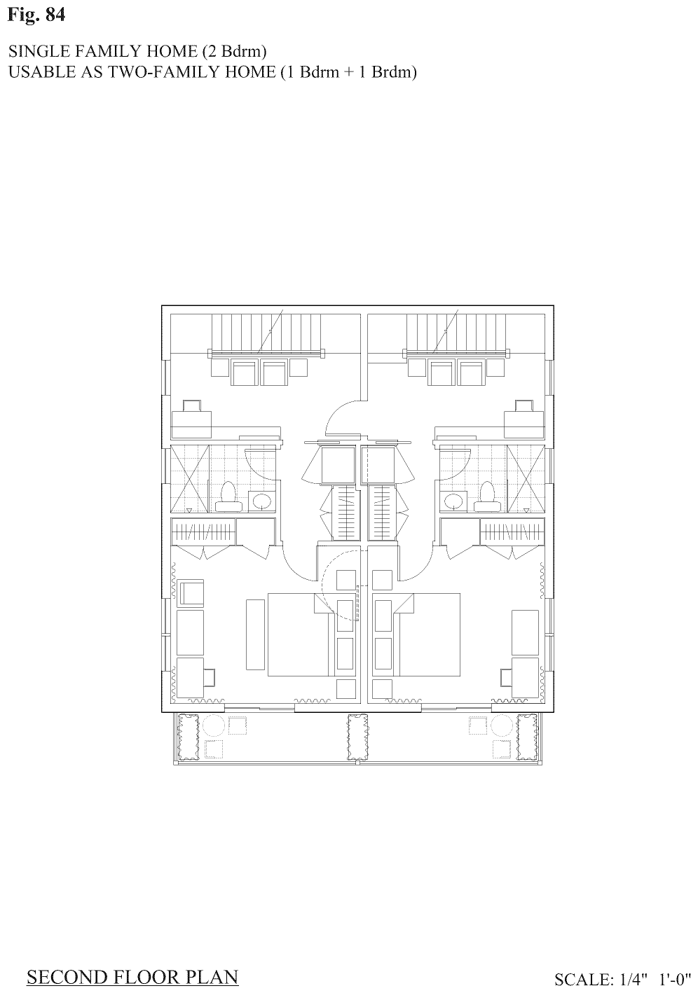

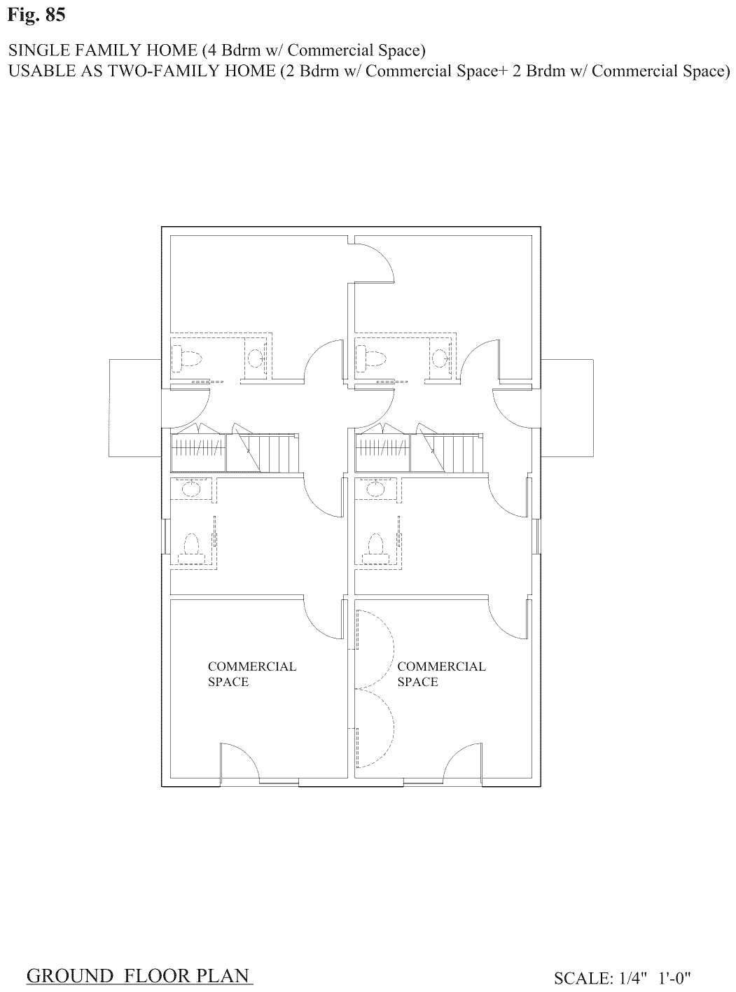

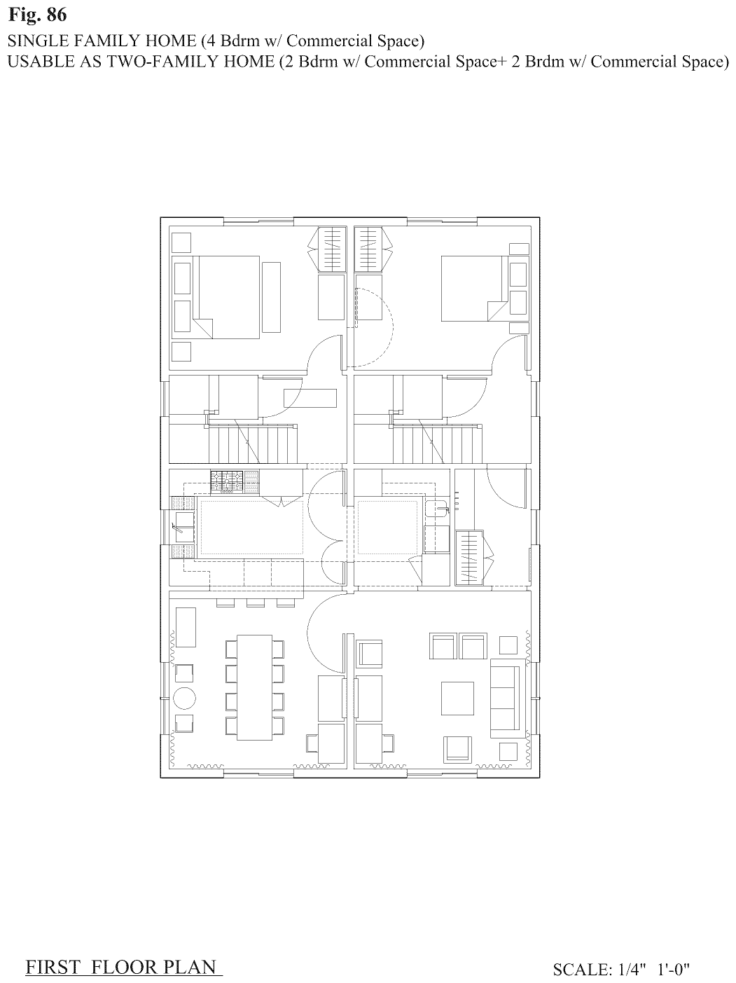

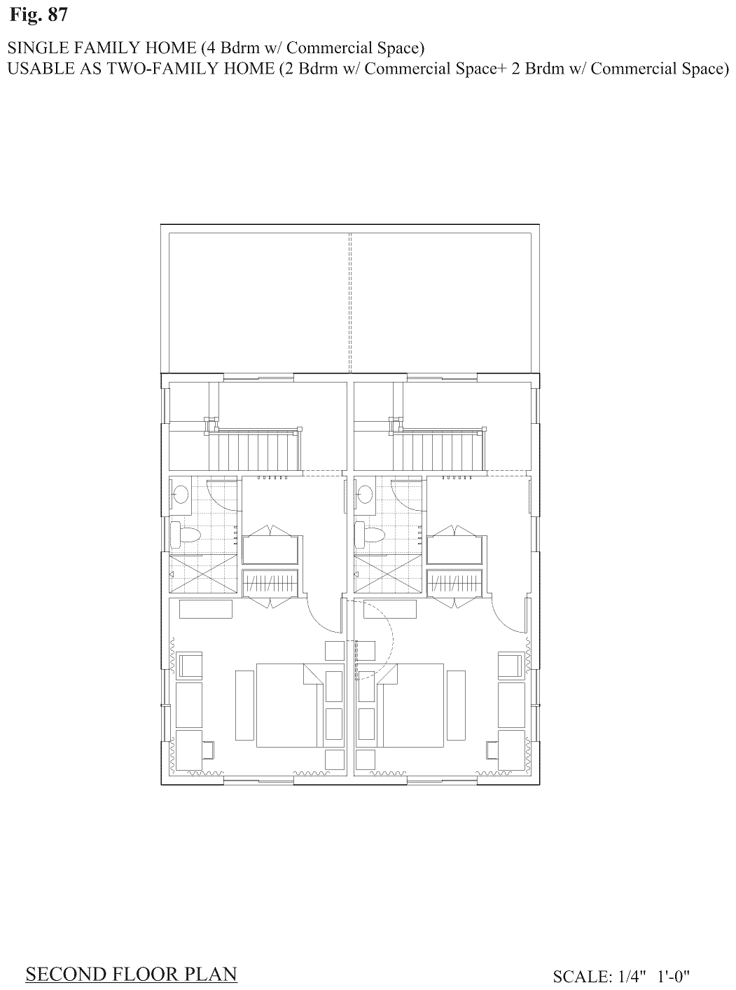

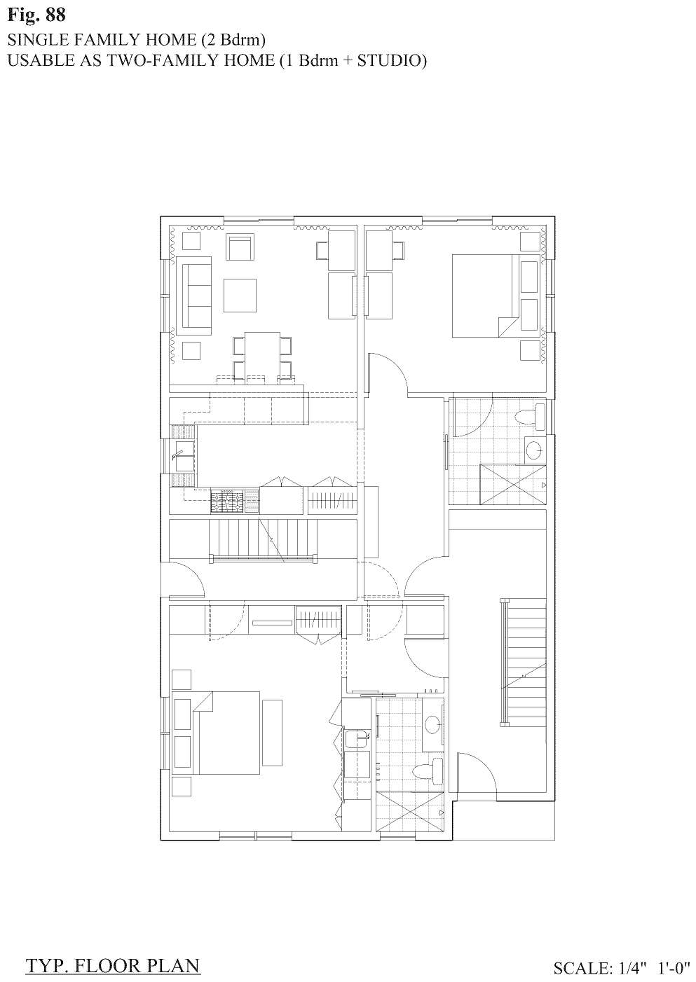

FIGS. 79 through 82 illustrate floor plans of a second exemplary embodiment for of triple-decker building type with two different dwellings. In the second exemplary embodiment, the ground floor and the first floor form a first flexible and multi-functional dwelling, and second floor and third floor form a second flexible and multi-functional dwelling.

Although the description below will focus on one of the two dwellings in the triple-decker building, the description also applied to the other dwelling in the triple-decker building. A single dwelling has at least two floors including a main floor (e.g., the first floor or the second floor) and a different floor (e.g., the basement or the third floor). The single dwelling includes perimeter walls defining an enclosable space, and interior walls. The interior walls in combination with the perimeter walls define a kitchen on the main floor (e.g., the first floor or the second floor) of the dwelling, the kitchen having a main kitchen area and a secondary kitchen area separated from the main kitchen area by a first interior wall having a cased opening forming a first interior doorway 1D sized to accommodate at least a single door. The interior walls and the perimeter walls also define a first multiuse room (e.g., dining room) adjacent to the main kitchen area on the main floor of the dwelling, a second multiuse room (e.g., living room) on the main floor of the dwelling adjacent to the secondary kitchen area and connected directly to the secondary kitchen area. The second multiuse room is separated from the first multiuse room by a second interior wall having a cased opening forming a second interior doorway 2D sized to accommodate at least a single door. The first multiuse room, the second multiuse room, and the kitchen forming a core of the dwelling. The interior walls and the perimeter walls also define a first entryway (e.g., entryway #1) on the main floor directly connected with the second multiuse room and directly connect with a first stair hall (e.g., stair hall #1) having first stairs leading to the different floor. The interior walls and the perimeter walls also define a second entryway (e.g., entryway #2) on the main floor connected to the main area of the kitchen through a second stair hall (e.g., stair hall #2) having second stairs leading to the different floor. The interior walls and the perimeter walls also define a first bedroom suite on the different floor of the dwelling and connected to the second multiuse room by a first staircase, the first bedroom suite including a first bedroom (e.g., bedroom #1) and a first bathroom (e.g., bathroom #1). The first bedroom suite is separated from the first staircase by a third interior wall having a cased opening forming a third interior doorway 3D. The interior walls and the perimeter walls also define a second bedroom suite on the different floor of the dwelling including a second bedroom (e.g., bedroom #2) and a second bathroom (e.g., bathroom #2), the second bedroom suite connected to the main kitchen area via the second stair hall. The interior walls and the perimeter walls also define a master bedroom suite on the main floor of the dwelling including a master bedroom and a master bathroom and connected to the main kitchen area via the second entryway and the second stair hall. The dwelling is configured for flexible use as one unit, two units, and three units based on securing doors of one or more interior doorways and based on using fire rated and lockable doors in one or more interior doorways.

### Innovative Design Element #1: Home Typology

Embodiments are a hybrid of a single and a multifamily home, innovatively designed for conventional construction with flexibility in use of spaces without any additional construction required.

FIG. 1 illustrates an example dwelling that is a single ground story free-standing home with the Option of use #1, as a single-family home, (e.g., fully owner occupied,) for up to eight household members.

The example dwelling is enclosed by perimeter walls. Internal walls of the dwelling and perimeter walls are configured to define a kitchen having a main kitchen area and a secondary kitchen area, a first multifunction room (e.g., dining room), a second multifunction room (e.g., a living room), a first bedroom suite including a first bathroom, a second bedroom suite including a second bathroom and also including a third bedroom, and a master bedroom suite including a master bedroom and a third bathroom, a first hall, and a second hall. As used herein, the term multifunction room is used to describe a room that that is configured for use as a living room, as a dining room, or both. The floor plan of FIG. 1 shows use of the dwelling as a standard single-family home.

FIGS. 2 through 7 illustrate Options of use #2 through 7, with the dwelling used as a multifamily home as well, either as a two- or three-family, in a variety of six multifamily options.

### Innovative Design Element #2: Layout of Spaces, Hallways, Walls & Doors

### Layout of Spaces:

FIG. 1 illustrates the Option of use #1, as a single-family 4-BR & 3-Bath dwelling. It is organized around a central kitchen, with adjacent pantry, and multifunction rooms (e.g. dining and living rooms), forming a central core of the dwelling. Adjacent to the central core are two bedroom suites, a first bedroom suite including single bedroom #1 and a second bedroom suit including bedroom #2 and bedroom #3 suite, each of the bedroom suites located on a different side of the central core. The master bedroom suite is separated from the first bedroom suite, the second bedroom suite and the core by one or more hallways (e.g., hall #1 and hall #2) from the rest of the dwelling, in a separate corner as well.

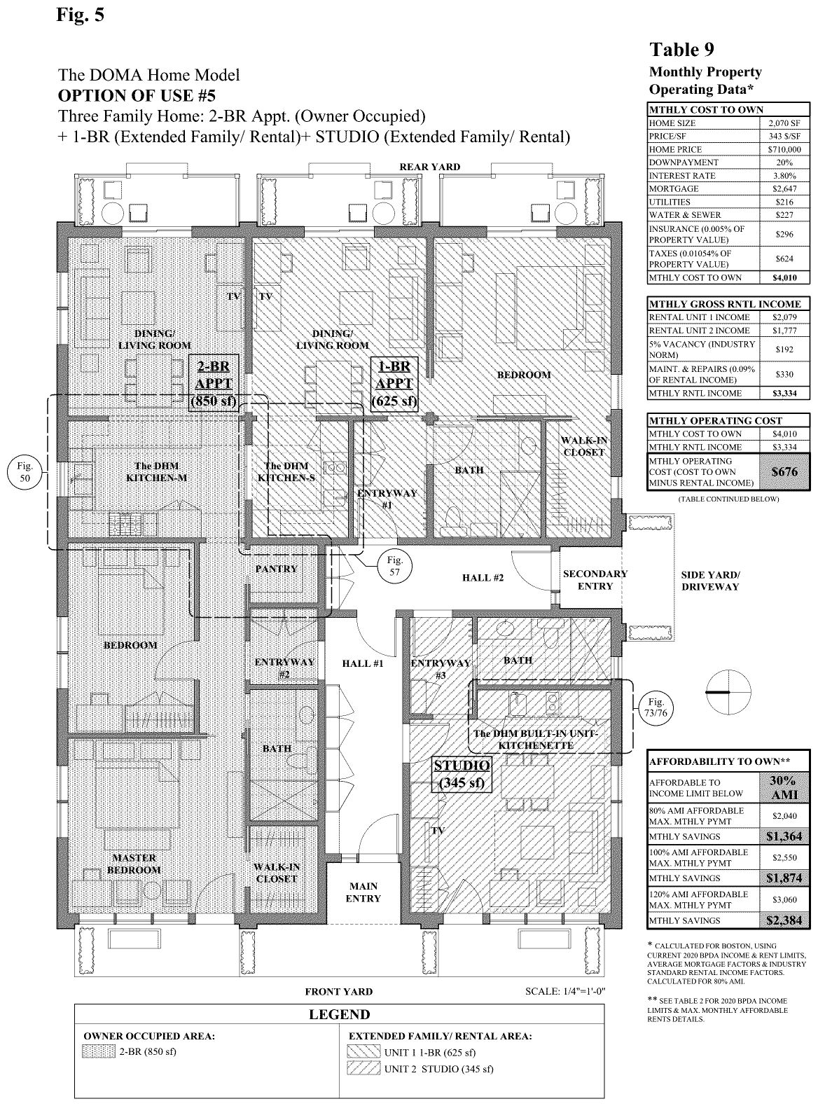

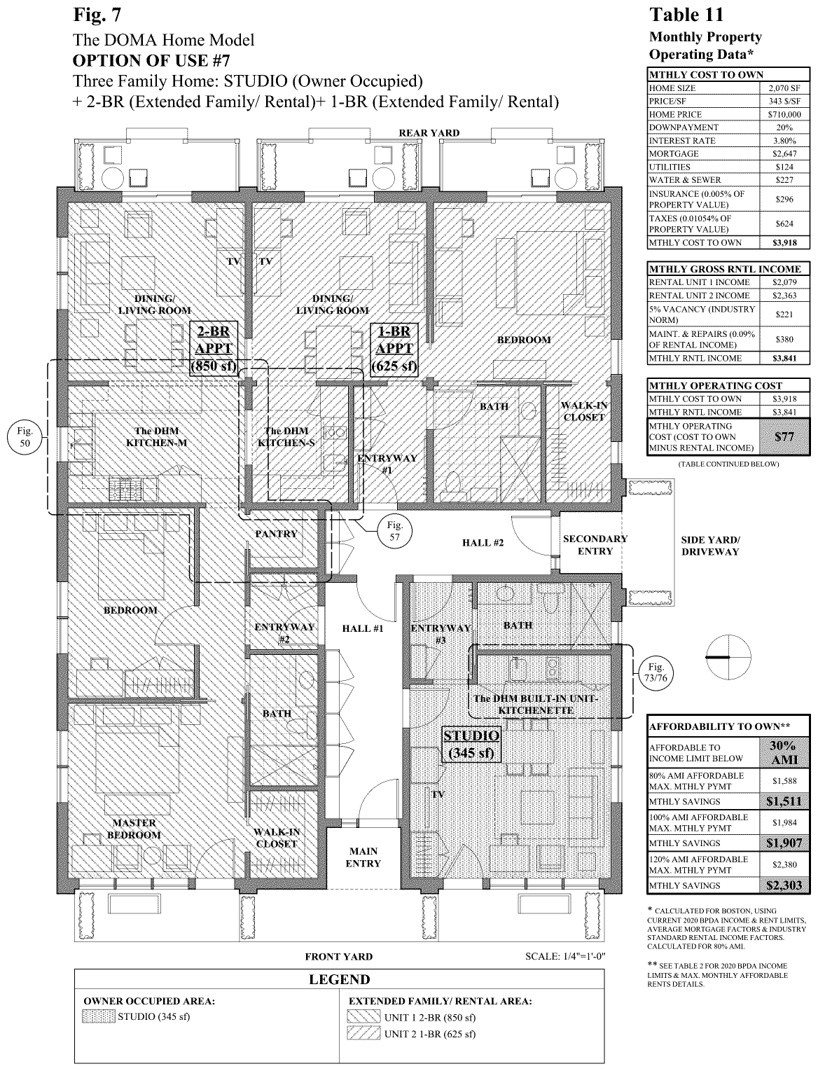

As shown on FIG. 1 through 7, the present invention allows the owner to use seven different size and layout readily available living options without any construction changes required. He can choose between the FIG. 1 4-BR 2,070 sf dwelling, FIG. 2 3-BR 1,490 sf dwelling, FIG. 3 3-BR 1,320 sf dwelling, FIG. 4 2-BR 1,070 sf dwelling, FIG. 5 2-BR 850 sf dwelling, FIG. 6 1-BR 625 sf dwelling and FIG. 7 Studio 345 sf dwelling. Sf areas are listed for reference only. This allows the owner to use the size and layout of a dwelling he currently needs and to easily change between different dwelling units as his needs change. Units he does not need can be rented out. As shown in FIGS. 1 through 7, the owner is allowed to use six different size and layout readily available rental options without any construction changes required. He can choose to rent out between the FIG. 2 Studio 345 sf dwelling, FIG. 3 1-BR 625 sf dwelling, FIG. 4 2-BR 850 sf dwelling, FIG. 5 1-BR 625 sf and Studio 345 sf dwellings, FIG. 6 2-BR 850 sf and Studio 345 sf dwellings and FIG. 7 1-BR 625 sf and 2-BR 850 sf dwellings. Sf areas are listed for reference only.

The size of the present invention, as disclosed by way of example, is determined with the goal to optimize between a maximizing both the comfort of living for the owner and the rental income, and minimizing of the overall sf dwelling area in order to limit the cost of construction.

The layout of walls and spaces allows for a compact and efficient 2,070 sf floor plan, with compact unit sizes as shown on Table 3, with comfortably sized bathrooms and comfortable bedrooms, dining and living spaces of approx. 13′-6″×13′-6″ size to allow for multiple furniture layouts and different uses of rooms throughout.

### Layout of Hallways:

The main entry and a secondary entry are located apart from each other, each with its own separate hallway, which are meeting in the center of the dwelling and are connected by a door. The dwelling is intended to be fully sprinklered, allowing by the Building Code for both exits to be apart min. ⅓ of the distance of the diagonal line across the dwelling. Each bedroom suite is accessible from one of the hallways through its own entryway. Single- and two-bedroom suites are accessible from a different hallway #1 or #2, and a master suite is accessible from both hallways #1 & #2.

A hallway design allows for each unit to have an independent access, required egress and privacy. FIG. 1 illustrates Option of use #1, where hallways #1 & 2 are used as a part of the whole dwelling. FIG. 2 illustrates Option of use #2, where hallways #1 & 2 are used as common. FIG. 3 illustrates Option of use #3, where hallway #1 is used as a part of the 3-BR unit & hallway #2 as common. Second means of egress for the 1-BR unit is allowed by the dining/living room exterior doors. FIG. 4 illustrates Option of use #4, where hallway #2 is used as a part of the 2-BR unit & hallway #1 as common. Second means of egress for the 2-BR unit is allowed by the dining/living room exterior doors. FIGS. 5, 6 & 7 illustrate Option of use #5, 6 & 7, where hallways #1 & 2 are used as common.

The studio provides a higher degree of privacy by being separated from the rest of the dwelling by a hallway. This allows, when dwelling is used for extended family living, to easily achieve different desired degrees of privacy, supporting better family connections. When the studio is used as a rental, the hallway layout ensures desired privacy as well.

### Layout of Walls & Doors:

The layout of walls and doors allows for an effortless separation of one and two-bedroom units by only closing of the kitchen door and the door between the dining and the living room, as shown on FIG. 1. When the present innovation is used for extended family, those two doors ensure a desired degree of privacy between dwelling areas, supporting better family connections as well. Walls, separating all unit options, are fire rated and doors in them are fire rated and lockable, as required per the Building Code.

### Universal/ADA Design:

In some embodiments, the whole dwelling is universally designed, with the one bedroom #1 suite and its bath #1 being fully ADA accessible.

### Innovative Design Element #3: Kitchen

The kitchen is designed compact in size but efficient to accommodate a wide variety of cooking tasks, with flexibility and for comfort of use.

### General Layout & Function:

The kitchen, as shown in FIGS. 30 through 41, is organized in two areas—a larger main kitchen area and a secondary kitchen area, as shown in FIG. 30. The main kitchen area is designated for the main food preparation, cooking, roasting, serving, cleanup and storage of daily cups, glasses and dishes. A secondary kitchen area is designated for baking, second cook, bar, breakfast, snacks, storage for entertaining, decorative, holiday & special occasion dishes, storage for extra and bulk food. Pantry is located adjacent to the larger kitchen area and accordingly sized, as shown in FIGS. 43 through 46.

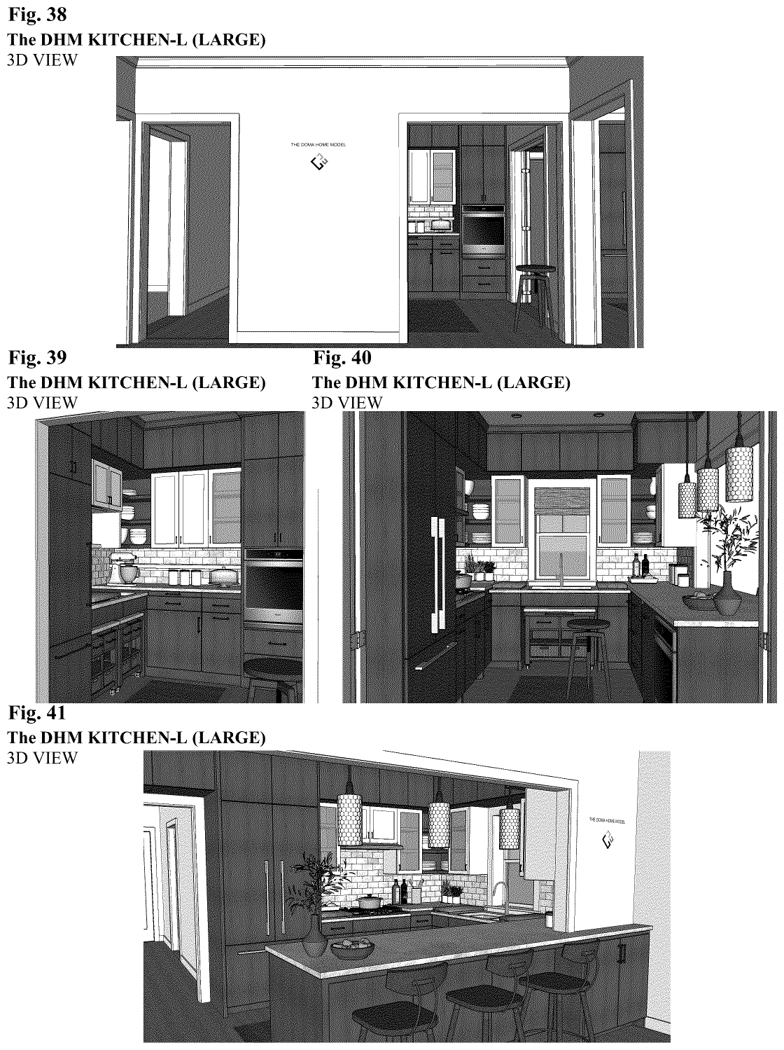

The main kitchen area and the secondary kitchen area are divided by a wall with a double door wide enough and fitting against the wall when fully open, so that both sides of the kitchen feel like one space, as shown in FIGS. 34, 38 & 40.

### Appliances:

As shown in FIGS. 30 through 41, the main kitchen area may be configured for or may have a large sink, a large cooktop with a hood, a dishwasher, a large refrigerator/freezer and a standard oven, with a refrigerator, cooktop and the sink forming a desired triangle use, meaning that they are in vicinity of each other to ensure comfortable basic daily cooking. The secondary kitchen area may be configured for or may have a smaller bar sink, smaller refrigerator/freezer and a wall oven. The secondary kitchen may be used for convenient daily specialty or for occasional service, like baking, a second cook, breakfast or larger volume food preparation or warming while entertaining, as a bar, a butler's pantry, etc. Located under upper cabinets is a sleek thin hood that fits narrowly under and is visible when in operation in and its glass extension pulled out, when a secondary kitchen area is used as a Kitchen-S(Small) (See Flexibility in use below).

### Countertops:

As shown in FIGS. 30 through 41, countertops are standard 36″ high with sections at the main sink, the cooktop and the secondary sink being 34″ high, with wood boards on top of them designated for drying dishes, placing hot pots, cutting and chopping food and a bread board for making bread, pastries and pasta, with top of wood boards being 36″ high to match the standard countertop height.

### Cabinets:

As shown in FIGS. 30 through 41, cabinets are designed to provide flexibility of use as well, by an open space under sinks and cooktops to allow legroom if a cook is sitting while working in the kitchen, and as spaces to accommodate movable carts. Upper cabinets are designed in two tiers, with the upper tier designed for storage, to ensure short and long-term comfort and greater efficiency.

### Moveable Features:

Under both sinks are carts on wheels designed for additional storage, working surfaces or food serving. Kitchen stools with adjustable height provide convenient seating for a cook, both shown in FIGS. 30 through 78.

### Flexibility of Use:

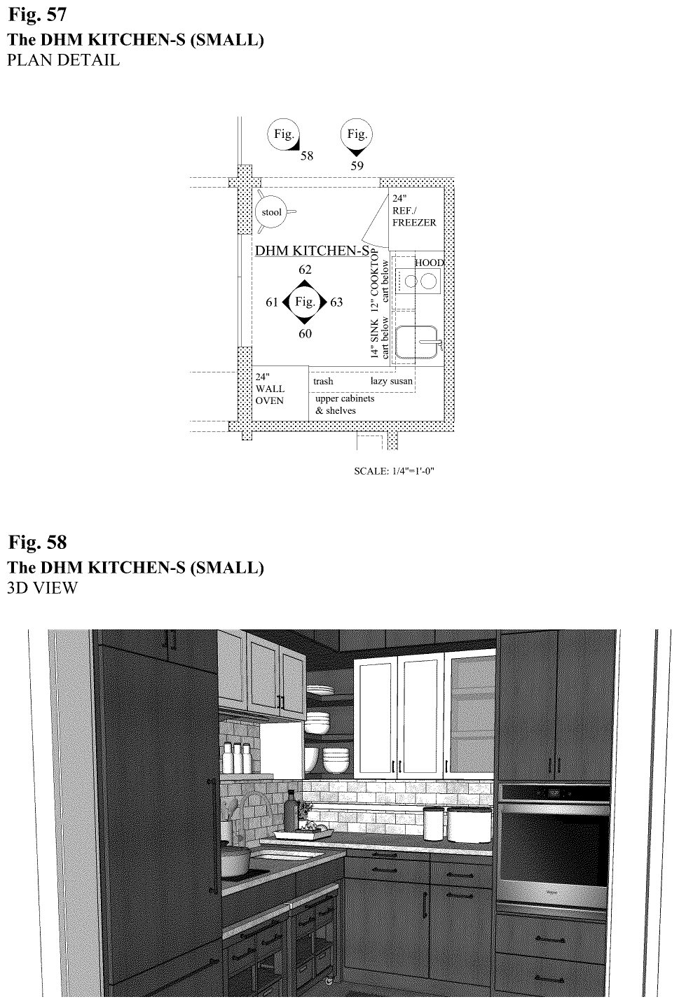

Embodiments of the kitchen design allows for the kitchen, noted as Kitchen-L (Large) in FIG. 1, and with previously mentioned design features, to be readily used as two independent kitchens, as shown in FIGS. 50 through 56 as Kitchen-M (Medium) and in FIGS. 57 through 63 as Kitchen-S(Small). This is achieved by simply closing the double door and removing of the bread board from the countertop in the Kitchen-S, to uncover an electric cooktop flush with the countertop, as shown in FIGS. 57 & 58.

This allows for a dwelling to be readily used as a to two-family dwelling, as shown in FIGS. 3 & 4, Options of Use #3 & 4, and a three-family dwelling, as shown in FIGS. 5, 6 & 7, Options of Use #5, 6 & 7.

### Universal/ADA Design:

The kitchen design is universal ADA, without being apparent and obvious. As shown in FIGS. 47 through 49, the kitchen is designed to accommodate wheelchair turning space clearance. The appliances are ADA accessible. Sinks and the cooktop are at the 34″ height, including the counter space next to them when wood boards are removed. Required open space under sinks is available when wheeled storage carts are moved away to be used or stored in the pantry, as shown in FIGS. 42 through 46, and the required cooktop open space below is available when cabinet doors underneath are removed away. The pantry is sized to be ADA accessible as well. The kitchen design allows for an effortless switching to the ADA use and back, either partially or whole.

### Innovative Design Element #4: Built-In Unit

### General Layout & Function:

The master bedroom Built-in Unit, as shown in FIGS. 64 through 72, is designed to be used for clothes storage and a central part as a wet bar, or kitchenette with a closed, partially or fully open middle folding doors that slide each in a side pocket.

### Appliances:

The built-in has a sink, a narrow refrigerator/freezer and a bar/file storage, all with panel doors. An electric cooktop flush with the countertop is covered with a bread board and not visible until a breadboard is removed, and the Unit used as a kitchenette. Kitchenette hood sleek thin design fits narrowly under upper cabinets and is visible when in operation and its glass extension pulled out (See Flexibility in use below).

### Moveable Features:

Undercounter carts can be removed, as well as middle drawer panels, to provide a legroom when the built-in is used as a home office. The kitchen stool with adjustable height provides convenient seating for a cook, when Unit is used as a kitchenette (See Flexibility in use below).

### Flexibility of Use:

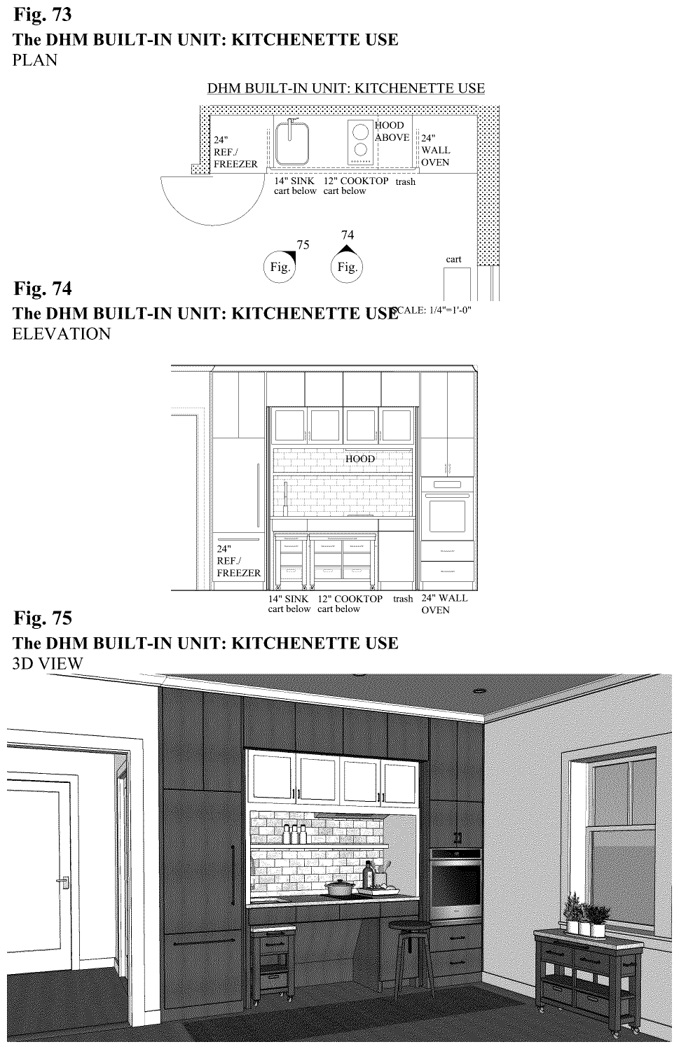

The Built-in Unit, as shown in FIGS. 73 through 75, is designed to readily be used as a kitchenette by removing of the bread board from the countertop to uncover an electric cooktop flush with the countertop and installing of the wall oven into the cabinet cavity. The hood is located narrowly under upper cabinets and is visible when in operation and its glass extension pulled out. Surrounding cabinets are designed for a kitchenette storage as well.

The Built-in Unit allows a master bedroom suite, as shown in FIG. 2, Option of use #2, to function as an independent Studio unit within the dwelling.

The Built-in Unit design with flexibility in use allows for the dwelling to function as a three-family as well, as shown in FIGS. 5, 6 & 7, Options of Use #5, 6 & 7.

### Universal/ADA Design:

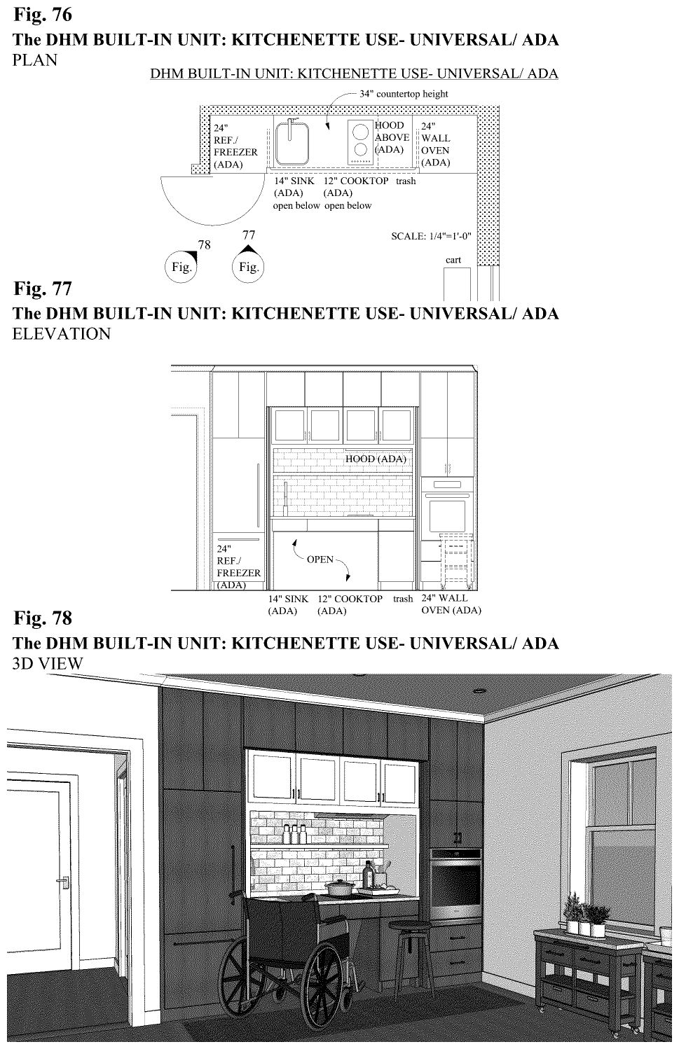

The Built-in Unit, as shown in FIGS. 76 through 78 is universally/ADA designed as well.

### Innovative Design Element #5: Affordability

One of the key features of the present invention is its outstanding affordability.

### Affordability:

Table 5 illustrates a monthly cost to own the dwelling of $4,100. Tables 6 through 11 illustrate how different monthly rental incomes reduce monthly operating cost of the dwelling and increase its affordability, reducing the monthly operating cost from $4,100 affordable to 150% Area Median Income (AMI) to $2,517 affordable to 90%/50% AMI, $2,256 affordable to 80%/50% AMI, $1,966 affordable to 80%/60% AMI, $676, $384 & $77, affordable at or below 30% AMI. Rental income amounts are selected in a range affordable to renters to illustrate the present invention is potentially a 100% affordable model for both owners and renters, in case rents can be controlled.

As described above, the present invention is sized for optimal rental manageability and outstanding affordability for a wide variety of middle-income owners, as shown in Tables 1 & 2.

### Savings and Financial Wellbeing:

In addition, as shown in Table 4, the present invention allows the homeowners to save the money they gain by spending less than the usual 30% of their income for housing. This allows for a significantly increased long-term financial security and wealth-building.

### Flexibility of Use:

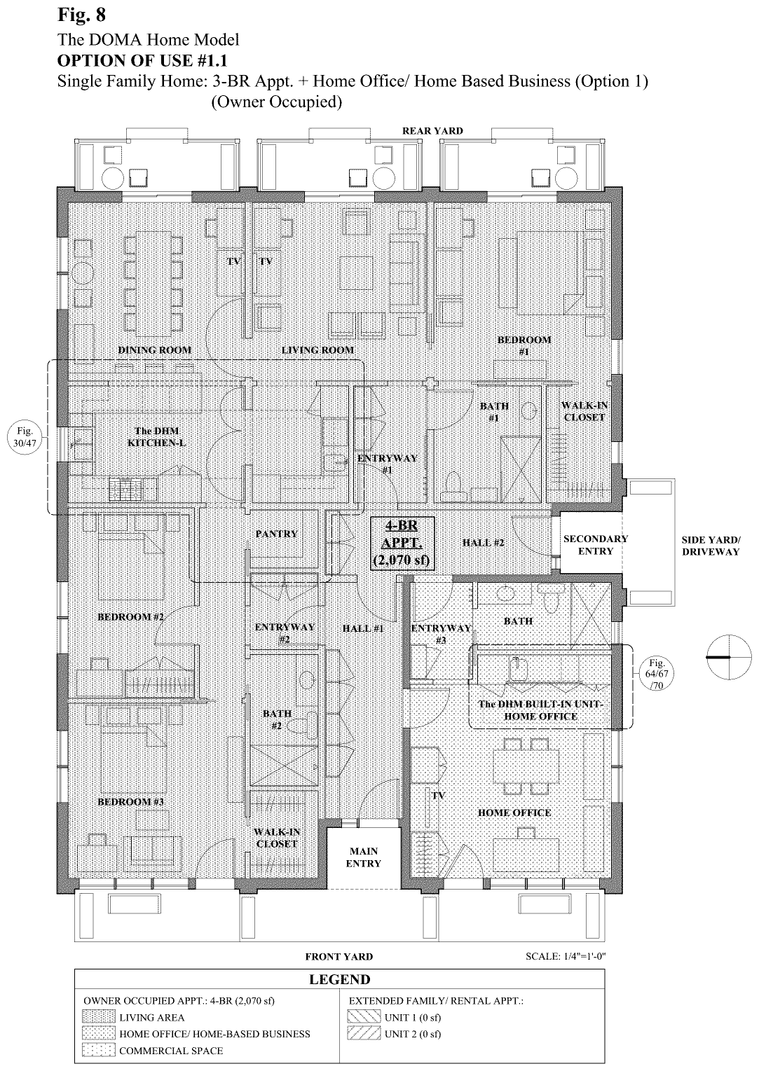

In addition to living spaces, as shown in FIGS. 8 through 29, parts of the dwelling can be used as a street-facing home office, a home-based business or a commercial space in up to twenty two different size and layout options, to allow and support working at home and developing and growing a business. In addition, the rear bedroom can be used as a home office/home based business as well. In addition to increased affordability, this allows for an increased comfort, quality of living and efficiency.

As shown in FIGS. 1 through 29, the five key innovative design features allow for a significantly increased efficiency of the present invention by allowing its full and continuous long-term use, long-term comfort, better family and wider social connections and quality of living, affordability and financial wellbeing and for a significantly climate-friendlier built environment as well.

### Building Type

One of ordinary skill in the art in view of the present disclosure will appreciate that embodiments of the present invention are not limited to use in a single ground story free-standing home or in triple-decker building type, but can be implemented on different footprints, on multiple stories and in various building types—as an apartment, a condo, a townhouse, a triple-decker, etc. with modifications that do not affect its scope and spirit, but merely with adjustments to access and egress with respect to the perimeter walls.

Although exemplary embodiments of the invention has been described in detail, it can be recognized that various substitutions and modifications may be made without departing from the scope and spirit of the invention as recited in the appended claims.

What is claimed is:

1. A single dwelling comprising:
perimeter walls defining an enclosable space; and
interior walls that in combination with the perimeter walls define:
a kitchen having a main kitchen area and a secondary kitchen area separated from the main kitchen area by a first interior wall having a cased opening forming a first interior doorway sized to accommodate at least a single door;
a first multiuse room adjacent to the main kitchen area and connected directly to the main kitchen area;
a second multiuse room adjacent to the secondary kitchen area and connected directly to the secondary kitchen area, the second multiuse room separated from the first multiuse room by a second interior wall having a cased opening forming a second interior doorway sized to accommodate at least a single door, the first multiuse room, the second multiuse room, and the kitchen forming a living core of the dwelling;
a first bedroom suite adjacent to the core of the dwelling on a first side and separated from the core of the dwelling by a third interior wall having a cased opening forming a third interior doorway sized to accommodate at least a single door, the first bedroom suite including a first bedroom and a first bathroom;
a second bedroom suite adjacent to the core of the dwelling on a second side and separated from the core of the dwelling at least in part by a fourth interior wall having a cased opening forming a fourth interior doorway sized to accommodate at least a single door, the second bedroom suite including a second bedroom and a second bathroom;
a first hall connecting at a first end with a main entry of the dwelling and separated from the second bedroom suite by a fifth interior wall having a cased opening forming a fifth interior doorway sized to accommodate at least a single door;
a second hall connecting at a first end with a secondary entry of the dwelling, a second end of the first hall separated from the second hall by a sixth interior wall having a cased opening forming a sixth interior doorway sized to accommodate at least a single door, the second hall separated from the first bedroom suite by a seventh interior wall having a cased opening forming a seventh interior doorway sized to accommodate at least a single door and providing access to the first bedroom suite and the second multipurpose room; and
a master bedroom suite including a master bedroom and a master bathroom, the master bedroom suite separated from the first bedroom suite by the first hall and separated from the second bedroom suite by the second hall, an eighth interior wall separating the first hallway and the master bedroom suite having a cased opening forming an eighth interior doorway sized to accommodate at least a single door, an internal wall separating the second hallway and the master bedroom suite having a cased opening forming a ninth interior doorway sized to accommodate at least a single door and providing access to the master bedroom suite;
wherein the dwelling is configured for flexible use as one unit, two units, and three units based on securing doors in one or more of the first interior doorway and the second interior doorway, and based on using fire rated and lockable doors in one or more of the first interior doorway, second interior doorway, fifth interior doorway, sixth interior doorway, seventh interior doorway, eighth interior doorway, and ninth interior doorway.

2. The single dwelling of claim 1, wherein the single dwelling is suitable for use as a single family home having at least three bedrooms [FIG. 1];
wherein, with lockable and fire rated doors in the first interior doorway, second interior doorway, sixth interior doorway, seventh interior doorway, and ninth interior doorway, and with the lockable and fire rated doors in the first interior doorway and second interior doorway secured, the single dwelling is suitable for use as a two family home [FIG. 3] including:
a first apartment comprising the first multipurpose room, the main kitchen area, the second bedroom suite, the first hall, and the master bedroom suite; and
a second apartment comprising the second multipurpose room, the secondary kitchen area and the first bedroom suite; and
wherein, with lockable and fire rated doors in the first interior doorway, second interior doorway, and sixth interior doorway, and with the lockable and fire rated doors in the first interior doorway and second interior doorway secured, the single dwelling is suitable for use as a two family home [FIG. 4] including:
a first apartment comprising the first multipurpose room, the main kitchen area, and the second bedroom suite; and
a second apartment comprising the second multipurpose room, the secondary kitchen area, the first bedroom suite, the second hall, and the master bedroom suite.

3. The single dwelling of claim 1 or claim 2, wherein the master bedroom suite is configured for a built in kitchen or kitchenette.

4. The single dwelling of claim 3, wherein, with lockable and fire rated doors in the sixth interior doorway, seventh interior doorway, and ninth interior doorway, the single dwelling is suitable for use as a two family home [FIG. 2] including:
a first apartment comprising the first multipurpose room, the second multipurpose room, the kitchen, the first bedroom suite, and the second bedroom suite; and
a second apartment comprising the master bedroom suite; and
wherein, with doors in the first interior doorway and in the second interior doorway secured, and with doors in the fifth interior doorway, the seventh interior doorway, the eighth interior doorway, and the ninth interior doorway suitable as outer apartment doors, the single dwelling is suitable for use as a three family home [FIG. 6] including:
a first apartment comprising the first multipurpose room, the main kitchen area, and the second bedroom suite; and
a second apartment comprising the second multipurpose room, the secondary kitchen area, and the first bedroom suite; and
a third studio apartment comprising the master bedroom suite.

5. The single dwelling of any one of claims 1 to 4, wherein the second bedroom suite also includes a third bedroom.

6. The single dwelling of claim 4, wherein the second bedroom suite is located at a ground floor of the dwelling, and wherein the third bedroom faces a front of the dwelling at a height accessible from the street and has an exterior entrance.

7. The single dwelling of any one of claims 1 to 6, wherein the first bedroom suite is adjacent to the second multipurpose room.

8. The single dwelling of any one of claims 1 to 7, wherein the second bedroom suite is adjacent to the kitchen.

9. The single dwelling of any one of claims 1 to 8, wherein the first bedroom suite also includes a first entryway providing access to the second hall through the seventh interior doorway.

10. The single dwelling of claim 9, wherein the second bedroom suite also includes a second entryway providing access to the first hall through the through the fifth interior doorway.

11. The single dwelling of claim 10, wherein the master bedroom suite also includes a third entryway providing access to the second hall through the ninth interior doorway.

12. The single dwelling of any one of claims 1 to 11, wherein each of the first multipurpose room and the second multipurpose room is sized and dimensioned to function as living room and as a dining room.

13. The single dwelling of any one of claims 1 to 10, the first kitchen area and second kitchen area are each configured to function as an independent kitchen and to function collectively as a single kitchen.

14. The single dwelling of any one of claims 1 to 13, wherein the first interior entryway corresponds to a wide double door.

15. The single dwelling of claim 14, further comprising a wide double door in the first interior entryway.

16. The single dwelling of claim 15, wherein the wide double door is sized and configured to lean against the first interior wall in a wide-open position.

17. The single dwelling of any one of claims 1 to 16, wherein the main kitchen area includes a main sink area and a main cooktop area.

18. The single dwelling of claim 17, further comprising counters in the main kitchen area with countertops at a height of 34 inches in a first portion of the main kitchen area adjacent to the main sink on a first side, in a second portion of the main kitchen area adjacent to main sink on a second side, and a third portion adjacent to the main cooktop area, and countertops in the rest of the main kitchen area having a height of 36 inches.

19. The single dwelling of claim 18, further comprising a first set of removable elements having a height of about two inches and configured to cover the countertops with the height of 34 inches in the first portion, second portion, and third portion of the main kitchen area.

20. The single dwelling of any one of claims 17 to 19, wherein the dwelling further comprises bottom cabinets in the main sink area and the main cooktop area, the bottom cabinets in the main sink area and the main cooktop area either fully open with no doors, or with removable doors, the bottom cabinets at least 30 inches wide clear to allow for wheelchair use.

21. The single dwelling of any one of claims 17 to 20, wherein the dwelling further comprises upper cabinets in the main kitchen area at a height of 52 inches above the floor.

22. The single dwelling of any one of claims 17 to 21, wherein the secondary kitchen area includes a secondary sink area and a secondary cooktop area.

23. The single dwelling of claim 22, further comprising counters in the secondary kitchen area with countertops at a height of 34 inches in a first portion of the secondary kitchen area adjacent to the secondary sink on a first side, in a second portion of the secondary kitchen area adjacent to the secondary sink on a second side, and a third portion adjacent to the secondary cooktop area, and countertops in the rest of the secondary kitchen area having a height of 36 inches.

24. The single dwelling of claim 23, further comprising a second set of removable elements having a height of about two inches and configured to cover the countertops with the height of 34 inches in the first portion, second portion, and third portion of the secondary kitchen area.

25. The single dwelling of any one of claims 21 to 24, wherein the dwelling further comprises bottom cabinets in the secondary sink area and secondary cooktop area, the bottom cabinets in the secondary sink area and the secondary cooktop area either fully open with no doors, or with removable doors, the bottom cabinets at least 30 inches wide clear to allow for wheelchair use.

26. The single dwelling of any one of claims 21 to 25, wherein the dwelling further comprises upper cabinets in the secondary kitchen area at a height of 52 inches above the floor.

27. The single dwelling of any one of claims 1 to 26, wherein the master bedroom is located at a ground floor of the dwelling, faces a front of the dwelling at a height accessible from a street and has an exterior entrance.

28. The single dwelling of any of claims 1 to 27, wherein the master bedroom is located at a ground floor of the dwelling and has an exterior entrance.

29. The single dwelling of any of claims 1 to 28, wherein hall sizes, door widths, and locations, sizes and spacings in the living core, the first bedroom suite, the second bedroom suite, and the master bedroom suite are consistent with handicap entry passage and use per ADA group 1.

30. The single dwelling of any one of claims 1 to 29, wherein the first bedroom suite is dimensioned for ADA group 2 accessibility; and
wherein the secondary kitchen area is dimensioned for ADA group 2 accessibility.

31. The single dwelling of any one of claims 1 to 30, wherein a perimeter of the dwelling has a first diagonal length and a second diagonal length, and wherein the main entry and the secondary entry are separated by a distance that is at least one third of the shorter of the first diagonal length and the second diagonal length.

32. The single dwelling of any one of claims 1 to 31, wherein a perimeter of the master suite has a third diagonal length and a fourth diagonal length, and wherein the eighth interior doorway and the ninth interior doorway are separated by a distance that is at least one third of the shorter of the third diagonal length and the fourth diagonal length.

33. The single dwelling of any one of claims 1 to 32, wherein the dwelling further comprises a built-in unit in the master suite, the built-in unit including:
a central portion including countertop and a sink;
a first end portion including a first cabinet configured to house a refrigerator, a freezer, both, or a combination refrigerator and freezer;
a second end portion including a second cabinet with one or more drawers; and
an upper portion including a third upper cabinet over the central portion between the first end portion and the second end portion.

34. The single dwelling of claim 33, further comprising full panel folding doors configured to cover the central portion when fully closed, each full panel folding door configured to slide into a side pocket when fully open.

35. The single dwelling of claim 34, wherein a depth of the first cabinet, the second cabinet, and the third cabinet are such that the full panel folding doors are flush with doors of the first cabinet, the second cabinet and the third cabinet when the full panel folding doors are closed.

36. The single dwelling of any one of claims 32-35, wherein the built-in unit further comprises removable undercounter face panels.

37. The single dwelling of any one of claims 33-36, wherein the sink of the built-in unit is flush with the countertop of the central portion of the built-in unit.

38. The dwelling of any one of claims 33-37, wherein the built-in unit sink has a faucet configured to be rotated to an orientation parallel with a back wall of the built-in unit.

39. The single dwelling of any one of claims 33-38, wherein the central portion of the built-in unit also includes a third cabinet including a drawer and a panel door.

40. The single dwelling of any one of claims 33-39, wherein the central portion of the built-in unit also includes an electric cooktop flush with the central portion countertop and a hood above the electric cooktop.

41. The single dwelling of claim 40, further comprising a removable element configured to cover the flush electric cooktop and function as a desktop when covering the flush electric cooktop.

42. The single dwelling of any one of claims 33-41, wherein the second cabinet of the built-in unit is configured to house a wall oven.

43. The single dwelling of any one of claims 33-42, wherein the one or more drawers of the second cabinet are dimensioned to be used as filing drawers.

44. A single dwelling having at least two floors including a main floor and a different floor and comprising:
perimeter walls defining an enclosable space; and
interior walls that in combination with the perimeter walls define:
a kitchen on the main floor of the dwelling, the kitchen having a main kitchen area and a secondary kitchen area separated from the main kitchen area by a first interior wall having a cased opening forming a first interior doorway sized to accommodate at least a single door;
a first multiuse room adjacent to the main kitchen area on the main floor of the dwelling;
a second multiuse room on the main floor of the dwelling adjacent to the secondary kitchen area and connected directly to the secondary kitchen area, the second multiuse room separated from the first multiuse room by a second interior wall having a cased opening forming a second interior doorway sized to accommodate at least a single door, the first multiuse room, the second multiuse room, and the kitchen forming a core of the dwelling;
a first entryway on the main floor directly connected with the living room and directly connect with a first stair hall having first stairs leading to the different floor;
a second entryway on the main floor connected to the main area of the kitchen through a second stair hall having second stairs leading to the different floor;
a first bedroom suite on the different floor of the dwelling and connected to the second multiuse room by a first staircase, the first bedroom suite including a first bedroom and a first bathroom, the first bedroom suite separated from the first staircase by a third interior wall having a cased opening forming a third interior doorway;
a second bedroom suite on the different floor of the dwelling including a second bedroom and a second bathroom, the second bedroom suite connected to the main kitchen area via the second stair hall;
a master bedroom suite on the main floor of the dwelling including a master bedroom and a master bathroom and connected to the main kitchen area via the second entryway and the second stair hall;
wherein the dwelling is configured for flexible use as one unit, two units, and three units based on securing doors of one or more interior doorways and based on using fire rated and lockable doors in one or more interior doorways.
